(19) United States
(12) Patent Application Publication
(10) Pub. No.: US 2026/0162524 A1
(43) Pub. Date: Jun. 11, 2026

(54) SYSTEM AND METHOD FOR IDENTIFICATION OF TRIP TAKEN BY A VEHICLE USING PROBE DATA

(71) Applicant: HERE Global B.V., Eindhoven (NL)

(72) Inventors: James Adeyemi FOWE, Chicago, IL (US); Bruce BERNHARDT, Wauconda, IL (US); Piotr KNAP, Chicago, IL (US)

(21) Appl. No.: 18/974,137

(22) Filed: Dec. 9, 2024

(51) Int. Cl. G08G 1/01

(52) U.S. Cl. CPC G08G 1/0133; G08G 1/0112

(57) ABSTRACT

The disclosure provides a system and method for identification of a trip taken by a vehicle using probe data. The system receives probe data associated with the vehicle comprising a plurality of probe points. Further, the system calculates a first distance between a first location associated with a first probe point of the plurality of probe points and a second location associated with a second probe point of the plurality of probe points based on the probe data. Furthermore, the system calculates a first travel time between the first location associated with the first probe point and the second location associated with the second probe point based on the probe data and identifies a first trip of the vehicle based on the calculated distance and the calculated first travel time. The system outputs first trip data associated with the first trip of the vehicle based on the probe data.

### TECHNICAL FIELD

The disclosure relates to the field of Intelligent Transportation Systems (ITS), and more specifically to a system and a method for identification of trips taken by a vehicle using probe data.

### BACKGROUND

Probe data, typically collected from GPS devices, smartphones, and vehicle telematics systems, provide valuable insights into travel patterns and behaviors across various transportation modes. Analyzing this data can reveal critical aspects of travel behavior, including route choice, travel patterns, driver behavior, and traffic demand. Such insights are vital for transportation planners and researchers aiming to develop more efficient and effective transportation systems. However, extracting meaningful trip information from raw probe data presents several challenges, including data noise, inconsistent sampling rates, and the need for efficient data storage and retrieval.

Existing methods for collecting and processing probe data from vehicles suffer from significant challenges, particularly in balancing user privacy with the extraction of key parameters from the data. Current solutions often rely on complex algorithms and data processing techniques that are both time-consuming and resource intensive. Consequently, there is a need for a system and method that can efficiently collect and process probe data from vehicles to extract useful information while ensuring that user privacy is maintained.

### BRIEF SUMMARY

The present disclosure provides systems and methods for identifying trips of vehicles in a straightforward and scalable manner. Some example embodiments are directed towards identification of vehicular trips from probe data associated with a vehicle. From the identified trips, the trip data may be extracted and stored in a multi-purpose trip database. The trip data may include information such as location information, time information, or the like associated with one or more vehicles. According to some example embodiments, the trip data stored in the multi-purpose trip database may be utilized for creating or improving various transportation services for end users. Additionally, or alternatively, in some embodiments the trip data may be provided as dynamic content data to other service providers, while protecting personal identifiable information (PII) associated with the probe data using which the trip data is generated. In an embodiment, an easy and fast access to query trips from the database may accelerate the delivery time for requests from end users. This approach allows for the development of a flexible trip database that can serve the needs of different products and customers.

In order to achieve the aforementioned objectives and advantages, example embodiments of the present disclosure provide a system, a method, and a computer program product for extracting trip data from probe data, which may be further used for improving traffic analytics.

In one aspect, a system for identifying a trip of vehicle is provided. The system may include a memory configured to store computer-executable instructions, and at least one processor configured to execute the computer-executable instructions. The processor may be configured to receive probe data that includes a plurality of probe points. The probe data is associated with a vehicle. Further, the processor may be configured to calculate a first distance between a first location associated with a first probe point of the plurality of probe points and a second location associated with a second probe point of the plurality of probe points based on the probe data. The second probe point is consecutive to the first probe point. Further, the processor may be configured to calculate a first travel time between the first location associated with the first probe point and the second location associated with the second probe point based on the probe data. The processor may be further configured to identify a first trip of the vehicle based on the calculated distance and the calculated first travel time. The first trip may include at least one of the first probe point, or the second probe point. Furthermore, the processor may be configured to output first trip data associated with the identified first trip of the vehicle based on the probe data.

In additional system embodiments, the processor may be further configured to identify the first trip of the vehicle to include the first probe point and the second probe point based on a determination that the calculated distance is less than a distance threshold and the calculated first travel time is less than a time threshold.

In additional system embodiments, the processor may be further configured to compare the calculated first travel time with a time threshold and a second time threshold. Further, the processor may be further configured to determine a waiting time associated with the calculated first travel time between the first probe point and the second probe point based on the comparison. Furthermore, the processor may be further configured to output the first trip data associated with the identified first trip of the vehicle based on the probe data. The first trip data may include the determined waiting time.

In additional system embodiments, the processor may be further configured to obtain tile level data associated with each of the first probe point and the second probe point from a map database. Further, the processor may be further configured to output first trip data associated with the identified first trip of the vehicle based on the obtained tile level data. The first trip data includes the obtained tile level data.

In additional system embodiments, the processor may be further configured to determine a probe count of the plurality of the probe points based on the received probe data. Further, the processor may be further configured to identify a journey of the vehicle based on a comparison of the determined probe count with a probe count threshold. Furthermore, the processor may be configured to identify the first trip of the vehicle within the identified journey.

In additional system embodiments, the first trip data associated with the identified first trip includes of a distance data indicative of a distance travelled by the vehicle in the first trip, time data associated with duration of the first trip, probe frequency data, and location data associated with an origin and a destination of the first trip.

In additional system embodiments, the location data associated with the origin and the destination of the first trip is determined based on the first location associated with the first probe point and the second location associated with the second probe point.

In additional system embodiments, the processor may be further configured to generate a first unique identifier associated with the first trip based on the received probe data. Further, the processor may be configured to associate the first unique identifier with the first trip. The first trip includes the first trip data. The processor may be further configured to store the first trip data in one or more databases. The first trip data is associated with the first trip.

In additional system embodiments, the processor may be further configured to calculate a second distance between a second location associated with the second probe point of the plurality of probe points and a third location associated with a third probe point of the plurality of probe points based on the probe data. The third probe point is consecutive to the second probe point. Further, the processor may be configured to calculate a second travel time between the second location and the third location associated with the second probe point based on the probe data. Furthermore, the processor may be configured to identify the first trip of the vehicle based on a determination that the calculated second distance is less than a distance threshold and the calculated second travel time is less than a time threshold. The first trip includes the third probe point.

In additional system embodiments, the processor may be configured to calculate a second distance between a second location associated with the second probe point of the plurality of probe points and a third location associated with a third probe point of the plurality of probe points based on the probe data. The third probe point is consecutive to the second probe point. The processor may be further configured to calculate a second travel time between the second location and the third location associated with the second probe point based on the probe data. Further, the processor may be configured to identify a second trip of the vehicle based on a determination that the calculated second distance is greater than a distance threshold and the calculated second travel time is greater than a time threshold. The second trip includes the third probe point.

In additional system embodiments, the processor may be configured to determine second trip data associated with the identified second trip of the vehicle. The processor may be further configured to generate a second unique identifier associated with the second trip based on the received probe data. The processor may be further configured to associate the second unique identifier with the second trip, wherein the second trip comprises the second trip data. The processor may be further configured to store the second trip data in one or more databases. The second trip data is associated with the second trip.

In another aspect, a method for identifying a trip of vehicle is disclosed. The method may include receiving probe data including a plurality of probe points. The probe data is associated with a vehicle. Further, the method may include calculating a first distance between a first location associated with a first probe point of the plurality of probe points and a second location associated with a second probe point of the plurality of probe points based on the probe data. The second probe point is consecutive to the first probe point. The method may further include calculating a first travel time between the first location associated with the first probe point and the second location associated with the second probe point based on the probe data. The method may further include identifying a first trip of the vehicle based on the calculated distance and the calculated first travel time. The first trip may include at least one of the first probe point, or the second probe point. Further, the method may include outputting first trip data associated with the identified first trip of the vehicle based on the probe data.

In additional method embodiments, the method may further include identifying the first trip of the vehicle to include the first probe point and the second probe point based on a determination that the calculated distance is less than a distance threshold and the calculated first travel time is less than a time threshold.

In additional method embodiments, the method may include comparing the calculated first-time threshold and the second time threshold. The method may further include determining a waiting time associated with the calculated first travel time between the first probe point and the second probe point based on the comparison. Further, the method may include outputting the first trip data associated with the identified first trip of the vehicle. The first trip data may include the determined waiting time.

In additional method embodiments, the method may include obtaining tile level data associated with each of the first probe point and the second probe point from a map database. The method may further include outputting first trip data associated with the identified first trip of the vehicle based on the obtained tile level data. The first trip data includes the obtained tile level data.

In additional method embodiments, the method may include determining a probe count of the plurality of the probe points based on the received probe data. The method may further include identifying a journey of the vehicle based on a comparison of the determined probe count with a probe count threshold. Further, the method may include identifying the first trip of the vehicle within the identified journey.

In additional method embodiments, the method may include generating a first unique identifier associated with the first trip based on the received probe data. The method may further include associating the first unique identifier with the first trip. The first trip includes the first trip data. Further, the method may include storing the first trip data in one or more databases. The first trip data is associated with the first trip.

In additional method embodiments, the method may include calculating a second distance between a second location associated with the second probe point of the plurality of probe points and a third location associated with a third probe point of the plurality of probe points based on the probe data. The third probe point is consecutive to the second probe point. The method may further include calculating a second travel time between the second location and the third location associated with the second probe point based on the probe data. Further, the method may include identifying the first trip of the vehicle based on a determination that the calculated second distance is less than a distance threshold and the calculated second travel time is less than a time threshold. The first trip includes the third probe point.

In additional method embodiments, the method may include calculating a second distance between a second location associated with the second probe point of the plurality of probe points and a third location associated with a third probe point of the plurality of probe points based on the probe data. The third probe point is consecutive to the second probe point. The method may further include calculating a second travel time between the second location and the third location associated with the second probe point based on the probe data. The method may further include identifying a second trip of the vehicle based on a determination that the calculated second distance is greater than a distance threshold and the calculated second travel time is greater than a time threshold. The second trip includes the third probe point.

In yet another aspect, a computer programmable product including a non-transitory computer readable medium having stored thereon computer executable instructions which when executed by one or more processors, cause the one or more processors to conduct operations for extracting trips from probe data. The operations may include receiving probe data including a plurality of probe points. The probe data is associated with a vehicle. The operation may further include calculating a first distance between a first location associated with a first probe point of the plurality of probe points and a second location associated with a second probe point of the plurality of probe points based on the probe data. The second probe point is consecutive to the first probe point. The operation may further include calculating a first travel time between the first location associated with the first probe point and the second location associated with the second probe point based on the probe data. The operation may further include identifying a first trip of the vehicle based on the calculated distance and the calculated first travel time. The first trip may include at least one of the first probe point, or the second probe point. Further, the operation may include outputting first trip data associated with the identified first trip of the vehicle based on the probe data.

With the ongoing industry segments, road traffic is sensed with the use of vision sensors, which do not cover the car's vision. To overcome this, some embodiments are directed towards using the car's vision to sense the road traffic. Some embodiments provide an ability to create a comprehensive suite of analytical insights that may refine the extraction of trip data from the probe data. The current invention provides an efficient architecture for extracting the trip data. The extracted trip data may be gathered in a timely manner and may be provided to other service providers. The trip data may be compatible with map technologies and may ensure at the same time that the privacy of the user from where the trip data was extracted is maintained.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates a schematic diagram of a network environment of a system for identification of trip taken by vehicle using probe data, in accordance with an embodiment of the disclosure;

FIG. 2 illustrates a block diagram of the system of FIG. 1, in accordance with an embodiment of the disclosure;

FIGS. 3A, 3B and 3C jointly illustrate exemplary operations for identifying a first trip taken by vehicle using probe data, in accordance with an embodiment of the disclosure;

FIG. 4 illustrates a flowchart for exemplary operations to identify a second trip taken by vehicle using probe data, in accordance with an embodiment of the disclosure;

FIG. 5 illustrates an exemplary map interface to determine estimated time of arrival (ETA) route of vehicle, in accordance with an embodiment of the disclosure;

FIG. 6 illustrates a block diagram of exemplary architecture for identification of a trip by the vehicle using probe data associated with a vehicle, in accordance with an embodiment of the disclosure;

FIG. 7 illustrates a flow chart for utilizing probe data to identify the trip of a vehicle, in accordance with an embodiment of the disclosure.

FIG. 8 illustrates an exemplary map database record storing data, in accordance with an embodiment of the disclosure.

FIG. 9 illustrates another exemplary map database record storing data, in accordance with an embodiment of the disclosure; and

FIG. 10 illustrates another exemplary map database storing data, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present invention relates to a method and a system for identification of trips taken by vehicles, using probe data. Trip data associated with the trips may be extracted from the probe data. The extracted trip data may be stored in a well-organized and efficiently indexed trip database. Accordingly, various embodiments provide the method and the system to extract the trip data related information from probe trajectory data or probe data. The probe data may be collected from vehicles, which may provide detailed information about travel patterns and trip dynamics. In another embodiment, the probe data may be received from one or more databases associated with one or more vendors of the probe data. The collected probe data may be used to estimate trip generation rates, study route choice behavior, and identify trip chaining patterns. Further, the probe data may improve accuracy of trip generation forecasts by providing detailed and real-time information about travel patterns and trip dynamics. Probe data may be further used to estimate the frequency of origins and destinations of trips in each zone, which is a critical step in the trip generation process. This data may help refine trip generation models and improve the accuracy of forecasts. Furthermore, probe data may be used to update trip generation forecasts in real-time, reflecting changes in travel patterns and traffic conditions.

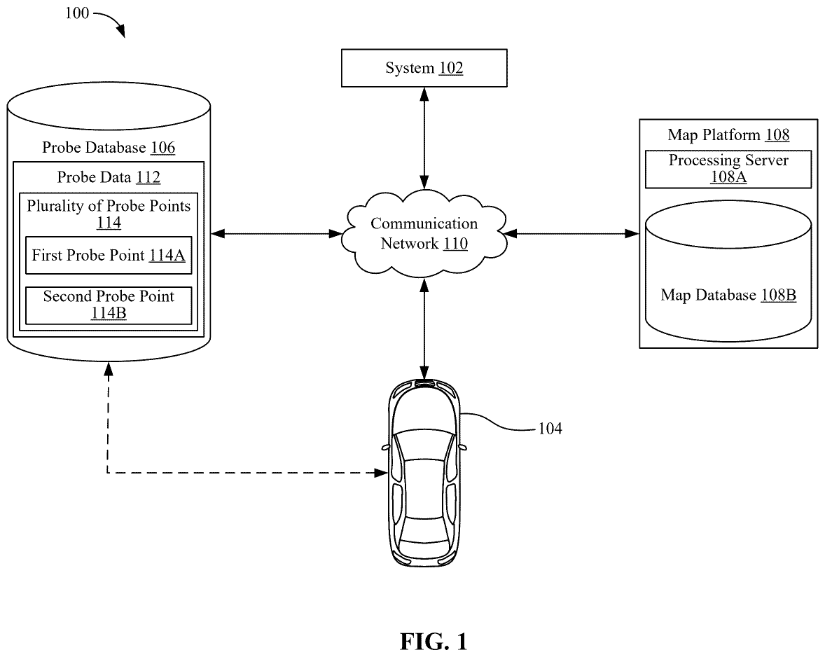

FIG. 1 illustrates a schematic diagram of a network environment 100 of a system 102 for identifying trip taken by a vehicle using the probe data, in accordance with an embodiment of the disclosure. The system 102 may be communicatively coupled to a vehicle 104, a probe database 106, and a mapping platform 108 via a communication network 110. Further, the probe database 106 may store probe data 112 associated with the vehicle 104. In an embodiment, the probe data 112 associated with the vehicle 104 includes a plurality of probe points 114 such as but not limited to a first probe point 114A and a second probe point 114B. The components described in the network environment 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

The system 102 may include suitable logic, circuitry, interfaces, and/or code that may be configured for identification of trip taken by the vehicle 104 using the probe data 112. In an embodiment, the system 102 may be configured to receive the probe data 112 including the plurality of probe points 114. The probe data 112 may be received from the vehicle 104 or the probe database 106. The system 102 may further calculate a first distance between a first location associated with the first probe point 114A of the plurality of probe points 114 and a second location associated with the second probe point 114B of the plurality of probe points 114 based on the probe data 112. The second probe point 114B may be consecutive to the first probe point 114A. The system 102 may further calculate a first travel time between the first location associated with the first probe point 114A and the second location associated with the second probe point 114B based on the probe data 112. The system 102 may further identify a first trip of the vehicle 104 based on the calculated first distance and the calculated first travel time. The first trip includes at least one of the first probe point 114A, or the second probe point 114B. The system 102 may further output first trip data associated with the identified first trip of the vehicle 104.

In an exemplary embodiment, the system 102 may be embodied in one or more of several ways as per the required implementation. For example, the system 102 may be embodied as a cloud-based service, a cloud-based application, a remote server-based service, a remote server-based application, a virtual computing system, a remote server platform or a cloud-based platform.

The vehicle 104 may be a non-autonomous vehicle, a semi-autonomous vehicle, or a fully autonomous vehicle, for example, as defined by National Highway Traffic Safety Administration (NHTSA). Examples of the vehicle 104 may include, but are not limited to, a two-wheeler electric vehicle, a three-wheeler electric vehicle, a four-wheeler electric vehicle, or more than a four-wheeler electric vehicle. Examples of two-wheeler vehicles may include, but are not limited to, an electric two-wheeler, or a hybrid two-wheeler. Similarly, examples of the four-wheeler vehicle may include, but are not limited to, an electric car, or a hybrid car. It may be noted here that the four-wheeler diagram of the vehicle 104 is merely shown as examples in FIG. 1. The present disclosure may also be applicable to other structures, designs, or shapes of the vehicle 104. The description of other types of vehicles and respective structures, designs, or shapes has been omitted from the disclosure for the sake of brevity.

In some example embodiments, the vehicle 104 may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the vehicle 104. In some example embodiments, one or more user equipment may be associated, coupled, or otherwise integrated with the vehicle 104, such as an advanced driver assistance system (ADAS), a personal navigation device (PND), a portable navigation device, and/or other devices that may be configured to provide route guidance and navigation-related functions to a user.

The probe database 106 may be a master probe database, but in alternate embodiments, the probe database 106 may be embodied as a client-side map database and may represent a compiled probe data database that may be used in or with end user equipment such as a user device to provide probe data and/or probe-related functions. The probe database 106 may be configured to store the probe data 112 over a period of time for the vehicle 104 to be at a link or road at a specific time. The probe data 112 may be collected by one or more devices in the vehicle 104 such as one or more sensors or image capturing devices or mobile devices. In an embodiment, the probe data 112 may also be captured from connected-car sensors, smartphones, personal navigation devices, fixed road sensors, smart-enabled commercial vehicles, and expert monitors observing accidents and construction. In an embodiment, the probe database 106 may be configured to store the probe counts on each road or area at any given time of the day and any day of the year. In an embodiment, the probe database 106 may be configured to store the probe data 112 including the plurality of probe points 114 that may include the first probe point 114A and the second probe point 114B.

The mapping platform 108 may include the map database 108B for storing map data and a processing server 108A. The map database 108B may store node data, road segment data, link data, point of interest (POI) data, link identification information, heading value records, data about various geographic zones, regions, pedestrian data for different regions, heat maps or the like. Also, the map database 108B further includes speed limit data of different lanes, cartographic data, routing data, and/or maneuvering data. Additionally, the map database 108B may be updated dynamically to accumulate real time traffic data. The real time traffic data may be collected by analyzing the location transmitted to the mapping platform 108 by a large number of road users through the respective user devices of the road users. In one example, by calculating the speed of the road users along a length of road, the mapping platform 108 may generate a live traffic map, which is stored in the map database 108B in the form of real time traffic conditions. In an embodiment, the map database 108B may store data of different zones in a region. In one embodiment, the map database 108B may further store historical traffic data that includes travel times and average speeds on each road or area at any given time of the day and any day of the year. In an embodiment, the map data in the map database 108B may be in the form of map tiles. Each map tile may denote a map tile area including a plurality of road segments or links within the map tile. According to some example embodiments, the road segment data records may be links or segments representing roads, streets, or paths, as may be used in calculating a route or recorded route information for determination of one or more personalized routes. The node data may be ending points corresponding to the respective links or segments of road segment data. The road link data and the node data may represent a road network used by vehicles such as cars, trucks, buses, motorcycles, and/or other entities. Optionally, the map database 108B may contain path segment and node data records, such as shape points or other data that may represent pedestrian paths, links, or areas in addition to or instead of the vehicle road record data, for example. The road/link and nodes may be associated with attributes, such as geographic coordinates, street names, address ranges, speed limits, turn restrictions at intersections, and other navigation related attributes. The map database 108B may also store data about the POIs and their respective locations in the POI records. The map database 108B may additionally store data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 108B may include event data (e.g., traffic incidents, construction activities, scheduled events, unscheduled events, accidents, diversions etc.) associated with the POI data records or other records of the map database 108B associated with the mapping platform 108. Optionally, the map database 108B may contain path segment records and node data records or other data that may represent pedestrian paths or areas in addition to or instead of the autonomous vehicle road record data.

As mentioned above, the map database 108B may be a master geographic database, but in alternate embodiments, the map database 108B may be embodied as a client-side map database and may represent a compiled navigation database that may be used in or with end user equipment such as the user device to provide navigation and/or map-related functions. For example, the map database 108B may be used with the user device to provide an end user with navigation features. In such a case, the map database 108B may be downloaded or stored locally (cached) on the user device.

The processing server 108A may include processing means, and communication means. For example, the processing means may include one or more processors configured to process requests received from the user device. The processing means may fetch map data from the map database 108B and transmit the same to the user device. In one or more example embodiments, the mapping platform 108 may periodically communicate with the user device via the processing server 108A to update a local cache of the map data stored on the user device. Accordingly, in some example embodiments, the map data may also be stored on the user device and may be updated based on periodic communication with the mapping platform 108.

In some example embodiments, the user device (not shown) may be any user accessible device such as a mobile phone, a smartphone, a portable computer, and the like, as a part of another portable/mobile object such as a vehicle. The user device may include a processor, a memory, and a communication interface. The processor, the memory and the communication interface may be communicatively coupled to each other. In some example embodiments, the user device may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user device may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user device. Additional, different, or fewer components may be provided. In one embodiment, the user device may be directly or indirectly coupled to the system 102 via the communication network 110. For example, the user device may be a dedicated vehicle (or a part thereof) for gathering data for development of the map data in the map database 108B. In some example embodiments, the user device may serve the dual purpose of a data gatherer and a beneficiary device. The user device may be configured to capture sensor data associated with a road which the user device may be traversing. The sensor data may for example be image data of road objects, road signs, or the surroundings. The sensor data may refer to sensor data collected from a sensor unit in the user device. In accordance with an embodiment, the sensor data may refer to the data captured by the vehicle 104 using sensors.

The communication network 110 may be wired, wireless, or any combination of wired and wireless communication networks, such as cellular, Wi-Fi, internet, local area networks, or the like. In one embodiment, the communication network 110 may include one or more networks such as a data network, a wireless network, a telephone network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 108 may be integrated into a single platform to provide a suite of mapping and navigation related applications for OEM devices, such as the user devices and the system 102. The system 102 may be configured to communicate with the mapping platform 108 over the communication network 110.

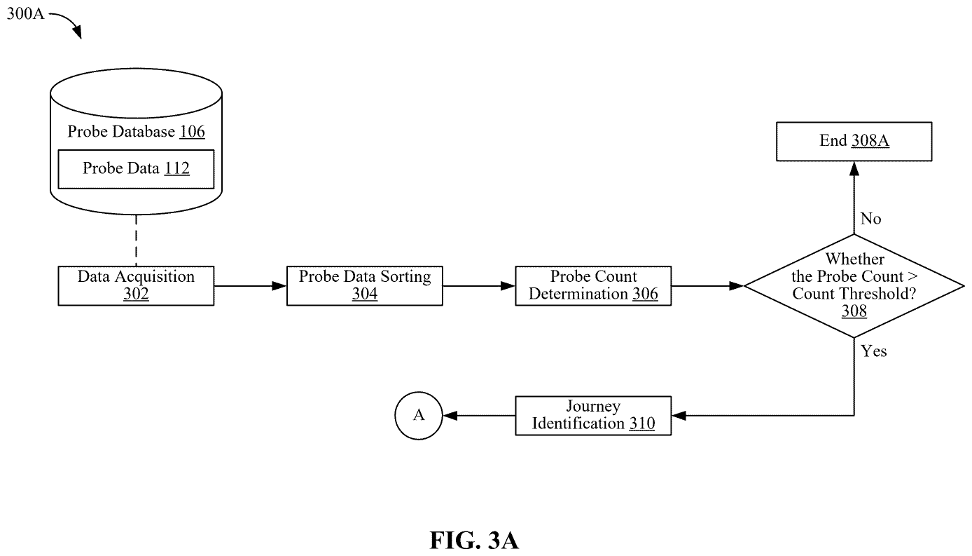

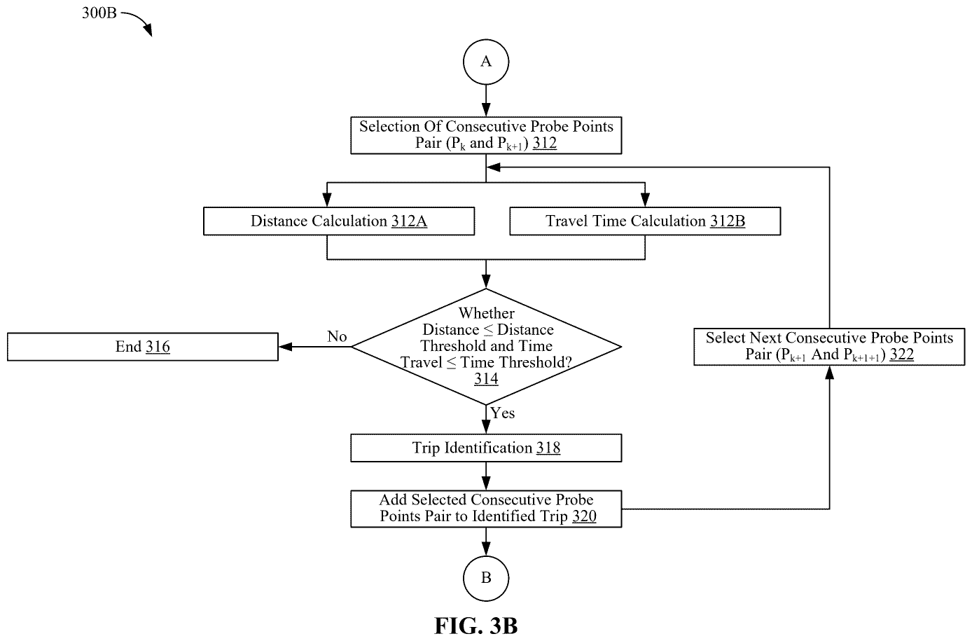

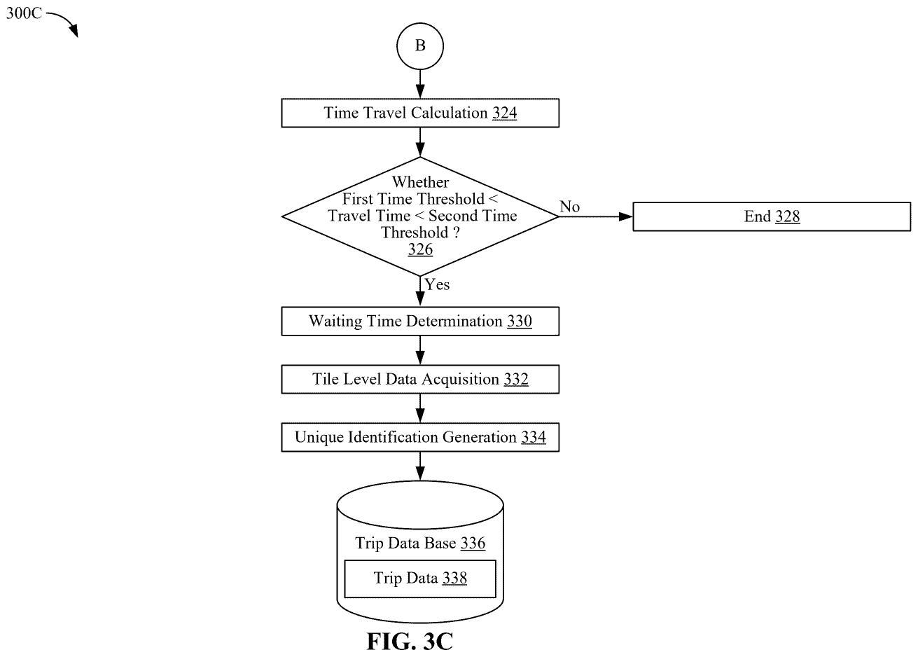

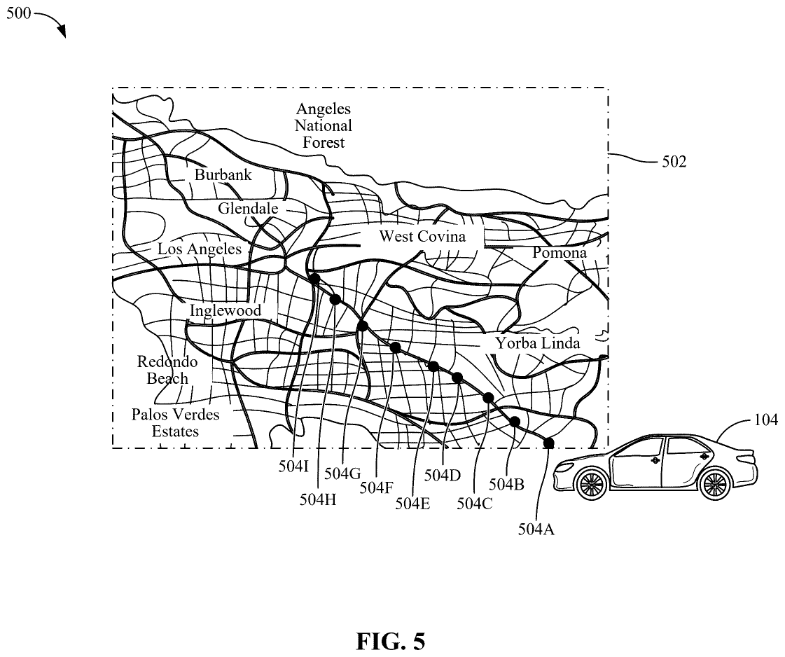

In operation, the system 102 may be configured to receive the probe data 112. The probe data 112 may include the plurality of probe points 114. The probe data 112 may be associated with the vehicle 104. In an embodiment, the probe data 112 may be stored in the probe database 106. Details about the received probe data 112 are provided, for example, in FIG. 3A and FIG. 5.

In an embodiment, the system 102 may be configured to calculate the first distance between the first location associated with the first probe point 114A of the plurality of probe points 114 and the second location associated with the second probe point 114B of the plurality of probe points 114. The first distance between the first location associated with the first probe point 114A of the plurality of probe points 114 and the second location associated with the second probe point 114B of the plurality of probe points 114 may be calculated based on the probe data 112. For example, a first set of geographical coordinates may be associated with the first location and a second set of geographical coordinates may be associated with the second location. The system 102 may be configured to determine the first distance between the first location and the second location by the map database 108B. In an embodiment, the second probe point 114B may be consecutive to the first probe point 114A. For example, the first distance between the first probe point 114A and the second probe point 114B may be 5 meters, 10 meters, 15 meters, 25 meters, 100 meters, 150 meters, etc. Details associated with the calculated first distance are provided, for example, in FIG. 3B.

In an embodiment, the system 102 may be further configured to calculate the first travel time between the first location associated with the first probe point 114A and the second location associated with the second probe point 114B. The first travel time between the first location associated with the first probe point 114A and the second location associated with the second probe point 114B may be calculated based on the probe data 112. For example, the first travel time may be calculated between the first location and the second location by calculating the difference between a first timestamp associated with the first location and a second timestamp associated with the second location. Details associated with the calculated first travel time are provided, for example, in FIG. 3C.

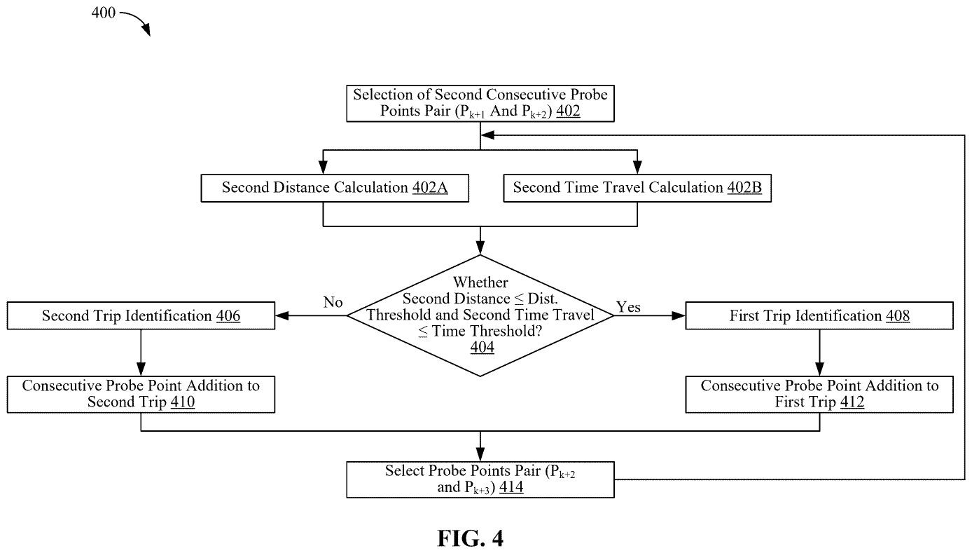

In an embodiment, the system 102 may be configured to identify the first trip of the vehicle 104 based on the calculated first distance and the calculated first travel time. The first trip may include at least one of the first probe point 114A, or the second probe point 114B. In an embodiment, the first trip of the vehicle 104 may be calculated based on a determination that the calculated first distance is greater than the distance threshold and the calculated first travel time is greater than the travel time threshold. In an exemplary embodiment, a distance between the first probe point 114A to second probe point 114B may be 100 meters and the travel time between the first probe point 114A to the second probe point 114B may be 60 seconds. The first trip may be identified based on the distance of 100 meters between the first probe point 114A and the second probe point 114B and the travel time of 60 seconds between the first probe point 114A and the second probe point 114B. Details associated with the identified first trip are provided, for example, in FIG. 4.

Further, the system 102 may be configured to output first trip data associated with the identified first trip of the vehicle 104 based on the probe data 112. For example, the first set of geographical coordinates may be associated with the first location and the second set of geographical coordinates may be associated with the second location. In an embodiment, the system 102 may be configured to determine the first distance between the first location and the second location based on the first set of geographical coordinates and the second set of geographical coordinates. Further, in another embodiment, the first trip data may be stored by the map database 108B of the mapping platform 108. The mapping platform 108 may use the trip data to enhance traffic analytics by exploring various applications such as origin-destination (OD) estimation, route recommendations, improved estimated times of arrival (ETAs), venue analytics, optimized routing for electric vehicles (EVs), and multi-modal transportation.

In an alternate embodiment, the system 102 may output the first trip data to the mapping platform 108 via the communication network 110. To that end, the system 102 may be communicatively coupled to the probe database 106 associated with the vehicle 104 and the mapping platform 108 via the communication network 110.

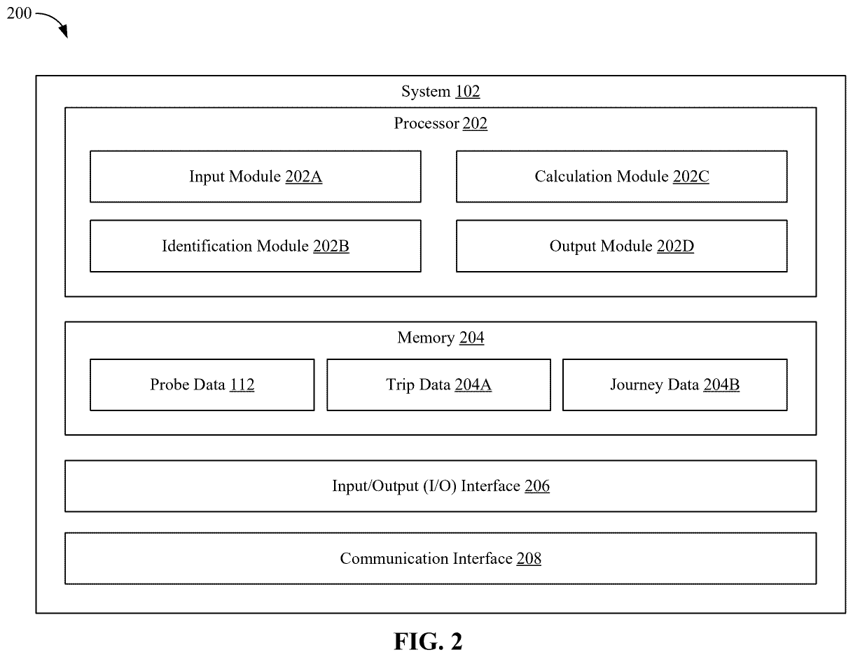

FIG. 2 illustrates a block diagram 200 of the system 102 for identifying a trip of the vehicle, in accordance with an example embodiment. The system 102 may include at least one processor 202 (hereinafter, also referred to as “processor 202”), at least one memory 204 (hereinafter, also referred to as “memory 204”), I/O interface 206 (hereinafter, also referred to as “I/O interface 206”), and communication interface 208 (hereinafter, also referred to as “communication interface 208”). The processor 202 may include an input module 202A, an identification module 202B, a calculation module 202C, and an output module 202D. The processor 202 may retrieve computer program code instructions that may be stored in the memory 204 for execution of the computer program code instructions. The memory 204 may store data including the probe data 112, trip data 204A, and journey data 204B.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 may be embodied as an executor of computer program code instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as the network environment 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102. In some embodiments, the user device associated with the user may be or correspond to an autonomous or a semi-autonomous vehicle. The IoT related capabilities may in turn be used to provide smart navigation solutions by providing real time updates to the users to take decision on turn-maneuvers, lane changes, big data analysis, traffic redirection, sensor-based data collection, and the like by using the cloud-based mapping system for providing navigation recommendation services. The extracted trip data from the trips may provide a relevant aspect of the trips to be used in a plurality of aspects such route recommendations, improved estimation of arrival times, optimized routes for navigation, multi modal transportation, or the like. The trip data extracted from trips may be used in product use cases. The extracted trip data may be defined, generated, and stored in a manner that the privacy of the user may be protected. The user may be associated with the trip from where the trip data is extracted. The system 102 may be accessed using the communication interface 208. The communication interface 208 may provide an interface for accessing various features and data stored in the system 102.

In an embodiment, the input module 202A of the processor 202 may receive probe data 112 including the plurality of probe points 114 such as but not limited to the first probe point 114A and the second probe point 114B. The probe data 112 may be associated with the vehicle 104. The input module 202A may receive the probe data 112 from one or more sensors including but not limited to acoustic sensors such as a microphone array, position sensors such as a GPS sensor, a gyroscope, motion sensors such as accelerometer, an image sensor such as a camera and the like. The probe data may include road traffic data. The road traffic data may be collected from the acoustic sensors. The vision of the vehicle 104 may be used to sense the road traffic data.

Furthermore, in another embodiment, the input module 202A of the processor 202 may further be configured to execute the computer program code instructions which may be configured to cause the system 102 to receive the probe data 112 including the plurality of probe points 114. The probe data 112 may be associated with the vehicle 104. In an example, the system 102 may output the first trip data associated with the identified first trip of the vehicle 104 based on the probe data 112, via a user interface.

The calculation module 202C may be configured to calculate the first distance between the first location associated with the first probe point 112A of the plurality of probe points 114 and the second location associated with the second probe point 112B of the plurality of probe points 114 based on the probe data 112. The second probe point 112B is consecutive to the first probe point 112A. Further, the calculation module 202C may be configured to calculate the first travel time between the first location associated with the first probe point 112A and the second location associated with the second probe point 112B based on the probe data 112.

The identification module 202B may be configured to identify the first trip associated with the vehicle 104. In an embodiment, upon the calculation of the first distance and first travel time between the first location associated with the first probe point 114A and the second location associated with the second probe point 114B, the processor 202 may be configured to identify the first trip associated with the vehicle 104. In an embodiment, the first trip associated with the vehicle 104 may be identified by the identification module 202B. The first trip associated with the vehicle 104 may be based on the calculated distance data and the calculated first travel time. The first trip may include at least one of the first probe point 112A, or the second probe point 112B.

The output module 202D may be configured to output the first trip data associated with the identified first trip of the vehicle 104. In an embodiment, the system 102 may be configured to output the first trip data associated with the identified first of the vehicle 104. In an embodiment, the first trip data may be outputted by the system 102. For example, the probe data 112 may include the calculated first distance and the calculated first travel time to be compared with the distance threshold and the travel time threshold accordingly. In an embodiment, the calculated travel time may be compared with the first-time threshold and the second time threshold to determine the waiting time associated with the vehicle 104. The first trip data may include the determined waiting time. The first trip data may also include tile level data obtained from the map database 108B.

The memory 204 of the system 102 may be configured to store the trip data 204A, the journey data 204B and the probe data 112. The trip data 204A may include at least one of a trip origin timestamp, a trip transportation mode, a trip origin city, a trip travel time of the vehicle 104, a trip tile ID associated with the origin and destination of the trip, a trip start latitude, a trip start longitude, a trip end latitude, a trip end longitude, a trip probe frequency of the probe, a trip dwell count of the vehicle 104, a trip probe data type. The journey data 204B may include at least one of a journey origin timestamp, a journey transportation mode, a journey origin city, a journey travel time of the vehicle 104, a journey tile ID associated with the origin and destination of the journey, a journey start latitude, a journey start longitude, a journey end latitude, a journey end longitude, a journey probe frequency of the probe, a journey dwell count of the vehicle 104, a journey probe data type. The trip data 204A may be a subset of the journey data 204B and may include the trip data 204A associated with the first trip. The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure.

For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may be configured to receive the input and/or output generated by the system 102. In an embodiment, the I/O interface 206 may be configured to communicate with the system 102 and display the input and/or output of the system 102. As such, the I/O interface 206 (for example, an infotainment system) may include a display screen and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display device and, in some embodiments, a plurality of speakers, a ringer, one or more microphones and/or the like. In an embodiment, the I/O interface 206 may include an input interface and output interface for supporting communications to and from the system 102 or any other component with which the system 102 may communicate. The processor 202 may be configured to control one or more functions of one or more I/O interface 206 elements through computer program instructions (for example, software and/or firmware) stored on the memory 204 accessible to the processor 202. The processor 202 may further render the first trip data associated with the identified first trip of the vehicle 104 via the user interface or the I/O interface.

The communication interface 208 may be any means such as a device or circuitry embodied in either hardware or a combination of hardware and software that is configured to receive and/or transmit data to/from other communication devices in communication with the system 102. In this regard, the communication interface 208 may include, for example, one or more antennas and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication port, a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning.

FIGS. 3A, 3B and 3C jointly illustrate exemplary operations for identifying trip information of a vehicle, in accordance with an embodiment of the disclosure. FIGS. 3A, 3B and 3C are explained in conjunction with elements from FIG. 1 and FIG. 2. With reference to FIG. 3A, there is shown the block diagram 300 that illustrates exemplary operations from 302 to 310, as described herein. The exemplary operations illustrated in the block diagram 300 may be performed by any computing system, apparatus, or device, such as by the system 102 of FIG. 1. Although illustrated with discrete blocks, the exemplary operations associated with one or more blocks of the block diagram 300 may be divided into additional blocks, combined into fewer blocks, or skipped, depending on the implementation.

At 302, a data acquisition operation may be executed. In the data acquisition operation, the system 102 may be configured to receive the probe data 112 from a probe database 106. The probe data 112 may be associated with the vehicle 104. In some embodiments, the probe data 112 may be received from a plurality of vehicles. In an embodiment, the probe data 112 may be collected from mobile devices associated with the vehicles. The plurality of vehicles and the mobile devices may be used to capture traffic conditions, road surface conditions, or the like. The probe data 112 may include the plurality of probe points 114 such as but not limited to the first probe point 114A to the second probe point 114B. A probe point is a record of a specific location of the vehicle 104 at a specific timestamp. The probe point may include the specific timestamp, and a set of geographical coordinates (latitude and longitude) associated with the vehicle 104. The probe point may include the speed of the vehicle 104 and a heading value associated with the vehicle 104. The speed of the vehicle 104 may correspond to velocity of the vehicle 104 at that specific point in time. The heading value may be indicative of a direction in which the vehicle 104 may be moving and is typically measured in degrees relative to true north (0° to 360°). In an exemplary embodiment, the plurality of probe points 114 may include the first probe point 114A as Pₖ and the second probe point 114B as Pₖ₊₁ up to an Nth probe point Pₙ.

At 304, a probe data sorting operation may be executed. In the probe data sorting operation, the system 102 may be configured to sort the probe data 112. In an embodiment, the probe data 112 may be sorted based on a device-ID. The device-ID may be associated with the vehicle 104. The device-ID may ensure that the probe data 112 associated with the vehicle 104 of a set of vehicles may be grouped or indexed in terms of the corresponding device ID. In an embodiment, the probe data 112 may additionally or alternately be sorted based on timestamp. The timestamp may be a specific value of time associated with each probe point of the plurality of probe points 114. In an embodiment, the probe data 112 may be sorted based on the combination of device-ID and timestamp. In an exemplary embodiment, the probe data 112 may be sorted based on the device-ID ‘CS-14072’ or based on the timestamp ‘13:11’ or based on a combination thereof.

At 306, a probe count determination operation may be executed. In the probe count determination operation, the system 102 may be configured to determine the probe count of the received probe data 112. The probe count may be determined based on the received probe data 112. In an embodiment, the system 102 may be configured to receive the probe data 112 from the probe database 106. The probe data 112 may be stored in the probe database 106 and transmitted to the system 102. In an embodiment, the system 102 may be configured to receive the probe data 112 from the vehicle 104. The vehicle may transmit the probe data 112 in a discrete time period (such as 5 milliseconds, 5 seconds, 5 minutes, 5 hours, and the like). The probe data 112 may be collated for the system 102 to receive the probe data 112 in an organized manner.

At 308, the system 102 may be configured to compare the determined probe count with the probe count threshold. The probe count threshold may be for example, 10, 12, 15, 20, 25. In an exemplary embodiment, the probe count threshold is 20. If the probe count is greater than the probe count threshold, the selected probe count may be considered as a journey associated with the vehicle 104. For example, if the probe data includes 25 probe points for the vehicle 104, the system 102 may be configured to include all the 25 probe points in a valid journey at step 310. On the contrary, if the probe count is less than the probe count threshold, the journey may not be considered as a valid journey. For instance, if the probe data includes 15 probe points for the vehicle 104, the system 102 may be configured to not identify this as valid journey, since the probe count associated with the vehicle 104 is below the probe count threshold.

In an embodiment, if the determined probe count is less than the probe count threshold, then the process may end at 308A. In an alternate embodiment, the system 102 may be configured to receive the probe data 112 at 302 and execute further operations from 304 to 308 till the determined probe count is greater than the probe count threshold. If the determined probe count is greater than the probe count threshold, then the process may further proceed to 310.

At 310, a journey identification operation may be executed. In the journey identification operation, the system 102 may be configured to identify the valid journey and the control of steps passes to step 312 of FIG. 3B. In an embodiment, the system 102 may be configured to identify the valid journey based on the comparison of the determined probe count with the probe count threshold. In an embodiment, the valid journey may include the plurality of probe points 114 associated with the vehicle 104. In an exemplary embodiment, the probe count threshold may be ‘20’. For example, the determined probe count may be 25. The determined probe count may be compared with the probe count threshold, the valid journey may be identified as the determined probe count is greater than the probe count threshold.

Referring to FIG. 3B, at 312, a consecutive probe points pair selection operation may be executed. In the consecutive probe points pair selection operation, the system 102 may be configured to select the consecutive probe points pair associated with the plurality of probe points 114 in the identified journey. The consecutive probe points pair may be selected from the plurality of probe points 114. The plurality of probe points 114 may include a set of probe points associated with the trip data 204A of the vehicle 104. As shown in FIG. 3B, the consecutive probe points pair may include a first selected probe point Pₖ and a second selected probe point Pₖ₊₁. The second selected probe point Pₖ₊₁ is consecutive to the first selected probe point Pₖ.

At 312A, a distance calculation operation may be executed. In the distance calculation operation, the system 102 may be configured to calculate the first distance associated with the selected consecutive probe points pair (Pₖ, Pₖ₊₁). The selected consecutive probe points pair (Pₖ, Pₖ₊₁) may be associated with the vehicle 104. In an embodiment, the system 102 may be configured to calculate the first distance between the first location associated with the first probe point 114A of the plurality of probe points 114 and the second location associated with the second probe point 114B of the plurality of probe points 114 based on the probe data 112.

At 312B, a travel time calculation operation may be executed. In the travel time calculation operation, the system 102 may be configured to calculate the first travel time associated with the first probe point 114A indicative of Pₖ and the second probe point 114B indicative of Pₖ₊₁. The selected consecutive probe points pair (Pₖ, Pₖ₊₁) may be associated with the vehicle 104. In an embodiment, the system 102 may be configured to calculate the first travel time between the first location associated with the first probe point 114A of the plurality of probe points 114 and the second location associated with the second probe point 114B of the plurality of probe points 114 based on the probe data 112. For example, the first travel time may be calculated between the first location and the second location by calculating the difference between the timestamp associated with the first location and the second location respectively. For example, the first travel time between the first probe point 114A and the second probe point 114B may be 2 minutes, 3 minutes, 5 minutes, 7 minutes, and 10 minutes.

At 314, a comparison may be made based on the determined first distance and/or the determined first travel time. In an embodiment, upon calculation of the first distance and first travel time between the first probe point 114A to the second probe point 114B, the system 102 may be configured to compare the first distance with a distance threshold. Additionally, or alternately, in an embodiment, the system 102 may be configured to compare the first travel time with a time threshold. For example, the time threshold may be determined based on a vehicle type, and the like. For instance, the time threshold associated with a two-wheeler vehicle may be determined differently as compared to the time threshold determined for a for wheeler vehicle, such as the time threshold for the two-wheeler vehicle may be 5 minutes and the time threshold for the four wheeler vehicle may be 10 minutes. For example, the time threshold for a commercial vehicle may vary from the time threshold for an emergency vehicle (such as ambulance, fire truck, or the like). In an embodiment, if the first distance is less than the distance threshold and/or the first travel time is less than the time threshold, then the process may proceed to 318 for trip identification. In an embodiment, if the first distance is greater than the distance threshold and the first travel time is greater than the time threshold, then the process may end at 316. In an embodiment, if the first distance is less than the distance threshold and the first travel time is greater than the time threshold, then the process may end at 316. In an embodiment, if the first distance is greater than the distance threshold and the first travel time is less than the time threshold, then the process may end at 316. In an embodiment, if the first distance is equal to the distance threshold and the first travel time is greater or less than or equal to the time threshold, then the process may end at 316. In an embodiment, if the first distance is greater than or less than or equal to the distance threshold and the first travel time is equal to the time threshold, then the process may end at 316. In an alternate embodiment, the system 102 may be configured to select the consecutive probe points pair at 312 and execute the further operations from 312 to 314 till the first distance is greater than the distance threshold and the first travel time is greater than the time threshold. For example, the distance threshold may be 200 and the time threshold may be 10 minutes. For example, if the first distance between the first probe point 114A to the second probe point 114B is 150 meters and the travel time from the first probe point 114A to the second probe point 114B is 3 minutes, then the probe points are considered as the first trip and added into the trip database. On the contrary, if the first distance between the first probe point 114A to the second probe point 114B is 250 meters, and the travel time from the first probe point 114A to the second probe point 114B is 15 minutes then the probe points are not considered as the first trip.

At 318, a first trip identification operation may be executed. In the first trip identification operation, the system 102 may be configured to identify the first trip of the vehicle 104. In an embodiment, the first trip may be identified based on the comparison of the first distance with the distance threshold and the comparison of the first travel time with the travel time threshold. In an embodiment, the first trip is identified if the first distance is greater than the distance threshold and the first travel time is greater than the time threshold. In an embodiment, the system 102 may be configured to identify the first trip of the vehicle 104 within the identified journey.

At 320, a selected consecutive probe points pair addition operation may be executed. In the selected consecutive probe points pair addition operation, the system 102 may be configured to add the selected consecutive probe points pair to the identified trip. The selected consecutive probe points pair may be the first selected probe point Pₖ and the second selected probe point Pₖ₊₁. In an embodiment, the system 102 may be configured to add the selected consecutive probe points pair to the first trip identified at 318.

At 322, a next consecutive probe points pair selection operation may be executed. In the next consecutive probe points pair selection operation, the system 102 may be configured to select the next consecutive probe points pair. The next consecutive probe points pair may include the second selected probe point Pₖ₊₁ and a third selected probe point Pₖ₊₂. The third selected probe point is consecutive to the second selected probe point. The next consecutive probe points pair may be further used to calculate the distance and the travel time for comparison with the distance threshold and the time threshold. In an embodiment, the system 102 may be configured to select the next consecutive probe points pair for the distance calculation operation at 312A and the travel time calculation at 312B.

Referring to FIG. 3C, at 324, a travel time filtration operation may be executed. In the travel time filtration operation, the system 102 may be configured to apply filter to the calculated first travel time to account for any waiting or idle time that may have occurred during the trip between the first probe point 114A and the second probe point 114B. The calculated travel time after the filtration may be compared with the first-time threshold and the second time threshold for the determination of waiting time.

At 326, a comparison may be made for the filtered first travel time. In an embodiment, the comparison may be made based on the first-time threshold and the second time threshold. In an embodiment, the system 102 may be configured to compare the filtered first travel time with the first-time threshold and the second time threshold. The filtered first travel time may be greater than the first-time threshold (T1) and less than the second time threshold (T2). In an embodiment, if the filtered first travel time is greater than the first-time threshold and less than the second time threshold, then the process may continue further at 330 for the waiting time determination. If the filtered first travel time is greater than the first-time threshold and greater than the second time threshold, then the process may end at 328. If the filtered first travel time is less than the first-time threshold and greater than the second time threshold, then the process may end at 328. If the filtered first travel time is less than the first-time threshold and less than the second time threshold, then the process may end at 328. In an embodiment, if the filtered first travel time is greater than the first-time threshold and the filtered travel time is equal to the second time threshold, then the process may end at 328. In another embodiment, if the filtered first travel time is equal to the first-time threshold and the filtered travel time is less than the second time threshold, then the process may end at 328. In an embodiment, the process may end at 328 and the operations from 324 to 326 may continue till the filtered travel time is greater than the first-time threshold and less than the second time threshold. For example, if the first-time threshold is 3 minutes and the second time threshold is 10 minutes. For example, if the filtered first travel time between the first probe point 114A to the second probe point 114B may be 7 minutes. In this case, the filtered first travel time may be further continued for the process of the waiting time determination at 330. For instance, if the filtered first travel time is 13 minutes, then the filtered first travel time is greater than the first-time threshold of 3 minutes but not less than the second time threshold of 10 minutes. In this case, the process may end at 328.

At 330, a waiting time determination operation may be executed. In the waiting time determination operation, the system 102 may be configured to determine the waiting time associated with the filtered first travel time. The filtered first travel time may be calculated between the first probe point 114A and the second probe point 114B. The filtered first travel time between the first probe point 114A and the second probe point 114B may be calculated based on the comparison of the filtered travel time with the first-time threshold and the second time threshold. The filtered travel time may be greater than the first-time threshold and less than the second time threshold.

At 332, a tile level data acquisition operation may be executed. In the tile level data acquisition operation, the system 102 may be configured to obtain the tile level data. In an embodiment, the system 102 may be configured to obtain the tile level data associated with the first probe point 114A and the second probe point 114B. The tile level data associated with the first probe point 114A and the second probe point 114B may be obtained from the map database 108B. Specifically, the tile level data may be indicative of the tile in which the first probe point 114A and the second probe point 114B may lie. In another embodiment, the tile level data may be associated with each probe point that may be included in the first trip. The obtained tile level data may be included in the first trip data.

At 334, a unique identification generation operation may be executed. In the unique identification generation operation, the system 102 may be configured to generate the first unique identifier associated with the first trip data associated with the first trip. The first unique identifier associated with the first trip data may be generated based on the received probe data 112. In an embodiment, the generated first unique identifier may be used to retrieve the first trip data that may be in one or more databases such as a trip database 336.

At 336, the trip database 336 may store the first trip data 338. In an embodiment, the system 102 may be configured to store the first trip data 338 in the trip database 336. In an embodiment, the system 102 may be configured to store the first unique identifier in the trip database 336. In an embodiment, the system 102 may be configured to store the tile level data in the trip database 336.

In an embodiment, the first trip data 338 associated with the first trip of the vehicle 104 may be stored in the trip database 336. The first trip data 338 associated with the identified first trip includes one of a distance data indicative of a distance travelled by the vehicle 104 in the first trip, time data indicative of a time duration of the first trip, probe frequency data indicative of a frequency at which the data points are captured by the probe, and location data associated with an origin and a destination of the first trip. Specifically, the first trip data may be stored in one or more tables in the trip database and may have a plurality of metrics indicative of the distance data, time data, probe frequency data, and location data.

By way of example and not limitation, the first trip data 338 may include metrics ‘origin_timestamp’, ‘transportation_mode’, ‘origin_city’, ‘tile level data’, ‘start_lat’, ‘start_lon’, ‘end_lat’, ‘end_lon’, ‘displacement_distance’, ‘probe_frequency’, ‘dwell_count’, ‘start_POI’, ‘end_POI’, ‘dwell_POI’, ‘start_TSE’, ‘end_TSE’ and ‘trip_ID’.

The ‘trip_ID’ may correspond to a unique identification of the first trip. The ‘origin_timestamp’ may be indicated as timestamp when the trip started, and the ‘transportation_mode’ may indicate the mode of transportation associated with the first trip. The mode of transportation may be car, bus, train, pedestrian, electric vehicle, truck, bike, and the like. Further, the ‘origin_city’ may indicate the city where the trip originated. The ‘tile level data’ associated with the first trip may indicate the Tile that may be traversed by the vehicle during the trip along with start and end probe indices in each tile. The ‘travel_time’ may indicate the total travel time of the first trip. The ‘start_lat’ may indicate the latitude of an origin of the corresponding trip, The ‘start_lon’ may indicate the longitude of the origin of the corresponding trip. The ‘end_lat’ may indicate the latitude of a destination of the corresponding trip. The ‘end_lon’ may may indicate the longitude of the destination of the corresponding trip. The ‘displacement_distance’ may indicate a straight-line distance between the origin and the destination (for example in meters). The ‘probe_frequency’ may indicate a frequency at which the probe points included in the first trip may be received. This may be calculated based on the timestamp information included in each probe record associated with the probe point. In an embodiment, the ‘probe_frequency’ may be equal to a median of a difference between each pair of consecutive probe points included in the first trip. The ‘dwell_count’ may indicate a count when the travel time of the vehicle 104 is greater than first-time threshold and less than the second time threshold. The ‘Start_POI’ may indicate points of interest near the origin of the trip and the ‘End_POI’ may indicate points of interest near the destination of the trip. The ‘dwell_POI’ may indicate a dwell time at the corresponding POI during the first trip. The ‘Start_TSE’ may indicate an estimated time of the start of the trip and ‘End_TSE’ may indicate an estimated time of the end of the trip. Such a comprehensive set of metrics may provide valuable insights into the characteristics and context of each trip, enabling detailed analysis of travel patterns and behavior.

Based on the above information, the first trip data 338 may be stored in the trip database 336. For a given journey or sequence of trips associated with the vehicle 104, there may be multiple trips recorded. Each individual trip may be assigned a unique trip ID, such as trip_ID1, trip_ID2, and trip_ID3, to identify the different trips that make up the overall journey. Further, each trip may be associated with its own origin timestamp that may indicate a timestamp of when the specific trip began. For example, the ‘origin_timestamp’ for of the first trip may be 12:00:00 PM, the ‘origin_timestamp’ for the second trip may be 01:00:00 PM, and ‘origin_timestamp’ for the third trip may be 02:00:00 PM. The ‘transportation_mode’ used for the trip may be for example, a car. Further, the ‘origin_city’ may indicate the city, for example—Los Angeles where the trip might have been originated. In an embodiment, the first trip associated with the vehicle 104 may include the first selected probe point P_{K} and the second selected probe point P_{K+1}. The tile level data may be associated with, for example, the first selected probe point P_{K}, and the second selected probe point P_{K+1} and may be indicative of specific Tile IDs that may be traversed during the trip. The tile level data may include an identifier of each tile of the one or more tiles (or Tile IDs) that may be traversed by the vehicle 104 in the identified first trip. For example, if the vehicle 104 traverse through Tile A, Tile B, up to Tile N in the first trip, then the tile level data may include, such as Tile_ID-A, Tile_ID-B up to Tile_ID-N. Here, the Tile_ID-A may be the identifier of Tile A, Tile_ID-B may be the identifier of Tile B, and Tile_ID-N may be the identifier of Tile N.

The tile may correspond to a small, rectangular section of a map, typically square-shaped, that forms part of a larger grid covering the entire map area. In an embodiment, the map may be divided into such tiles to efficiently load and render geographic information. Each tile may represent a specific geographic area at a certain zoom level, with higher zoom levels consisting of more, smaller tiles to provide greater detail. Such tiling system allows maps to be loaded incrementally as users pan and zoom, ensuring smoother performance and reduced data usage. The Tile IDs may include at least one of a zoom level indicative of a scale value of a map, a row number indicative of a row position in the grid associated with the map, a column number indicative of a column position in the grid associated with the map. For example, the Tile_IDA may be represented as zoom level/row number/column number such as May 12, 2014. The tile level data may further include a ‘start probe_index’ and an ‘end_probe_index’ that may be indicative of an index of the starting probe point (or a first probe point) that may be captured in the corresponding tile and the index of the ending probe point (or a last probe point) that may be captured in the corresponding tile. may be associated with each tile of the specific Tile IDs. The “travel_time” may indicate the total travel time of the corresponding trip. For example, the first travel-time may be 50 minutes. The “start_lat” may be 34.052235 and the ‘start_lon’ may be −120.052235. The ‘end_lat’ may be 34.052270. The ‘end_lon’ may be −120.052135. The ‘displacement_distance’ may indicate a straight-line distance between the origin and the destination and may be 500 meters. The ‘probe_frequency’ may be, for example, 25 seconds. The ‘dwell_count’ may be, for example, 3. The first trip data may be stored in trip database 336 to analyze travel patterns, identify congestion, and study how people move through a city.

In an embodiment, the first trip data may also include trip origin-destination (OD) data. The trip OD data may be determined based on the identified first trip and may be stored in a first table the trip database 336. The first table may store the trip OD data associated with each trip (such as the first trip and the second trip). The trip OD data may include multiple metrics such as, but not limited to, ‘start_lat’, ‘start_lon’, ‘end_lat’, ‘end_lon’, ‘origin_timestamp’ and ‘transportation_mode’. To access the trip OD data, the system 102 may be configured to generate a unique trip OD key (such as ‘trip_deviceid_provider’). Such a unique trip OD key may be associated with each trip in the first trip data 338. The trip OD key may be used as a primary key to store and fetch the trip OD data from the first table of the trip database 336. The trip OD key ‘trip_deviceid_provider’ may be indicative of a trip identifier, a device identifier associated with the vehicle 104, and a provider indicative of a name of the source of the probe data. For example, the trip OD key ‘tripl_D1_ABC’ may be associated with a first trip of the vehicle whose identifier is ‘D1’ and the probe data is provided by ‘ABC’. The trip OD key may be used to store and retrieve a specific trip from the trip database 336

In another embodiment, the first trip data may also include probe trajectory data. The probe trajectory data may be associated with a probe trajectory and may be stored in a second table the trip database 336. The second table may store the probe trajectory data associated with each probe trajectory. The trip OD data may include multiple metrics such as, but not limited to, ‘mm_lat-lon’, ‘time’, ‘heading’, ‘speed’, ‘d-value’, and ‘mm_type’ associated with each probe point of the plurality of probe points 114, ‘probe_frequency’, ‘mode’ and ‘mode_conf’. The ‘mm_lat-lon’ may correspond to a map match latitude and longitude value associated with the corresponding latitude and longitude captured at the probe point and included in the probe data record associated with the corresponding probe point. The ‘time’ may correspond to a timestamp value included in the probe data record associated with the corresponding probe point. The ‘heading’ and ‘speed’ may correspond to a heading value and a speed value included in the probe data record associated with the corresponding probe point. The ‘d-value’ may correspond to a deviation value of the location included in the probe point and the map matched location. The ‘mm_type’ may correspond to a type or a classification of the probe point. The ‘probe_frequency’ may correspond to the frequency at which the probe data may be sampled or recorded. The “mode” may correspond to the type of transportation that may be used for at the time of capturing the plurality of probe records, and the ‘mode_conf’ may correspond to the confidence level in determining the mode.

In an embodiment, a unique probe trajectory key (such as ‘seqid_deviceid_provider’) may be associated with the probe trajectory data. The probe trajectory key may be used as a primary key to store and fetch the probe trajectory data from the second table of the trip database 336. The probe trajectory key ‘seqid_deviceid_provider’ may be indicative of a sequence number associated with the probe trajectory, a device ID associated with the vehicle 104, and a provider indicative of a source name (such as a third party provider of the probe trajectory) from where the probe data may be received. For example, the probe trajectory is ‘S12_D2_XYZ’. The probe trajectory is received from the provider ‘XYZ’ with the sequence number ‘S12’ associated with the device ‘D2’.

In an embodiment, trip trajectory data of the first trip may be stored in the trip database 336. A unique trip trajectory key (such as ‘tripid_deviceid_provider’) may be associated with the trip trajectory of the first trip. The trip trajectory key may be used as a primary key to store and retrieve a specific trip trajectory from the trip database 336. The trip trajectory key ‘tripid_deviceid_provider’ may be indicative of a trip ID associated with the probe, a device ID associated with the vehicle 104 from where the probe data 112 is received, and a provider indicative of a source name (such as a third party provider of the trip trajectory) from where the trip OD data is received. For example, the trip trajectory key is ‘tripid1_D3_PQR’. The trip trajectory is received from the provider ‘PQR’ of ‘tripid1’ associated with device ‘D3’. The trip trajectory may include the probe trajectory associated with the first trip of the vehicle 104.

Such data stored in the trip database 336 may be used to improve variety of services such as, but not limited to, traffic Analysis and Management, enhanced route optimization, enhanced mapping and navigation, fleet management, Urban Planning and Policy Making, and the like that may be offered by mapping platforms. Such improvement in above-mentioned services may result in the enhancement of user experience.

FIG. 4 is a diagram that illustrates exemplary operations for identifying trip information of a vehicle, in accordance with an embodiment of the disclosure. FIG. 4 is explained in conjunction with elements from FIG. 1, FIG. 2, FIG. 3A, FIG. 3B and FIG. 3C. With reference to FIG. 4, there is shown the block diagram 400 that illustrates exemplary operations from 402 to 414, as described herein. The exemplary operations illustrated in the block diagram 400 may be performed by any computing system, apparatus, or device, such as by the system 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the implementation.

At 402A, a second distance calculation operation may be executed. In the second distance calculation operation, the system 102 may be configured to calculate the second distance associated with the selected consecutive probe points pair (Pₖ₊₁, Pₖ₊₂). The selected second consecutive probe points pair (Pₖ₊₁, Pₖ₊₂) may be associated with the vehicle 104. In an embodiment, the system 102 may be configured to calculate the second distance between the first location associated with the first probe point 114A of the plurality of probe points 114 and the second location associated with the second probe point 114B of the plurality of probe points 114 based on the probe data 112. As shown in FIG. 3B, in an instance, the first probe point 114A and the second probe point 114B may resemble Pₖ₊₁ and Pₖ₊₂ respectively.

At 402B, a second travel time calculation operation may be executed. In the second travel time calculation operation, the system 102 may be configured to calculate the second travel time associated with the selected second consecutive probe points pair (Pₖ₊₁, Pₖ₊₂). The selected second consecutive probe points pair (Pₖ₊₁, Pₖ₊₂) may be associated with the vehicle 104. In an embodiment, the system 102 may be configured to calculate the second travel time between the first location associated with the first probe point 114A of the plurality of probe points 114 and the second location associated with the second probe point 114B of the plurality of probe points 114 based on the probe data 112. As shown in FIG. 3B, in an instance, the first probe point 114A and the second probe point 114B may resemble Pₖ₊₁ and Pₖ₊₂ respectively.

At 404, a comparison may be made based on the determined second distance and the determined second travel time. In an embodiment, upon calculation of the second distance and second time travel between the first probe point 114A and the second probe point 114B, the system 102 may be configured to compare the second distance with the distance threshold. In an embodiment, the system 102 may be configured to compare the second travel time with the time threshold. In an embodiment, if the second distance is less than the distance threshold and the second travel time is less than the time threshold, then the process may proceed to 408 for first trip identification. In an embodiment, if the first distance is greater than the distance threshold and the first travel time is greater than the time threshold, then the process may proceed to 406 for second trip identification. In an embodiment, if the first distance is less than the distance threshold and the first travel time is greater than the time threshold, then the process may proceed to 406 for the second trip identification. In an embodiment, if the first distance is greater than the distance threshold and the first travel time is less than the time threshold, then the process may proceed to 406 for second trip identification. For example, the distance threshold may be 200 and the time threshold may be 10 minutes. For example, if the second distance between the first probe point 114A to the second probe point 114B is 150 meters and the travel time from the first probe point 114A to the second probe point 114B is 3 minutes, then the probe points are associated with the first trip and added into the trip database 336. On the contrary, if the second distance between the first probe point 114A to the second probe point 114B is 250 meters, and the travel time from the first probe point 114A to the second probe point 114B is 15 minutes then the probe points are not associated with the second trip.

At 406, a second trip identification operation may be executed. In the second trip identification operation, the system 102 may be configured to identify the second trip based on the comparison of the second distance with the distance threshold and the comparison of the second travel time with the travel time threshold. In an embodiment, if the second distance is greater than the distance threshold and the second travel time is greater than the time threshold, then the second trip may be identified. In an embodiment, if the second distance is greater than the distance threshold and the second travel time is less than the time threshold, then the second trip may be identified. In an embodiment, if the second distance is less than the distance threshold and the second travel time is greater than the time threshold, then the second trip may be identified. In an embodiment, the system 102 may be configured to identify the second trip of the vehicle 104 within the identified journey.

At 408, a first trip identification operation may be executed. In the first trip identification operation, the system 102 may be configured to identify the first trip. In an embodiment, the first trip may be identified based on the comparison of the second distance with the distance threshold and the comparison of the second travel time with the travel time threshold. In an embodiment, if the second distance is less than the distance threshold and the second travel time is less than the time threshold, then the first trip may be identified. In an embodiment, the system 102 may be configured to identify the first trip of the vehicle 104 within the identified journey.

At 410, a selected second consecutive probe points pair addition operation may be executed. In the selected second consecutive probe points pair addition operation, the system 102 may be configured to add the selected second consecutive probe points pair to the identified second trip. The selected second consecutive probe points pair may be the first selected probe point Pₖ₊₁ and the second selected probe point Pₖ₊₂. The selected second consecutive probe points pair may be added to the identified second trip for the next consecutive probe points pair to be computed for distance and time calculation.

At 412, a selected second consecutive probe points pair addition operation may be executed. In the selected second consecutive probe points pair addition operation, the system 102 may be configured to add the selected second consecutive probe points pair to the identified first trip. The selected second consecutive probe points pair may be the first selected probe point Pₖ₊₁ and the second selected probe point Pₖ₊₂. The selected second consecutive probe points pair may be added to the identified first trip for the next consecutive probe points pair to be computed for distance and time calculation.

At 414, a next second consecutive probe points pair selection operation may be executed. In the next second consecutive probe points pair selection operation, the system 102 may be configured to select the next second consecutive probe points pair. The next second consecutive probe points pair may include the second selected probe point Pₖ₊₂ and the third selected probe point Pₖ₊₃. The third selected probe point is consecutive to the second selected probe point. The next second consecutive probe points pair may be further used to calculate the distance, and the travel time associated with the next consecutive probe points pair for comparison with the distance threshold and the time threshold.

FIG. 5 illustrates an exemplary ETA route map associated with a trajectory of the vehicle 104, in accordance with an embodiment of the disclosure. FIG. 5 is explained in conjunction with elements from FIG. 1, FIG. 2, FIG. 3, and FIG. 4. With reference to FIG. 5, there is shown exemplary ETA route 500 associated with ETA route map 502 of the trajectory of the vehicle 104. The ETA route map 502 may be considered as a journey which includes one or more probe points for example, but not limited to 504A, 504B, 504C, 504D, 504E, 504F, 504G, 504H, 504I, and 504J. The processor 202 may be configured to identify the first trip of the vehicle 104. The first trip may be identified based on the calculated first distance being less than the distance threshold and the calculated first travel time being less than the time threshold. The distance threshold is 200 meters, and the travel time is 10 minutes.

In an exemplary embodiment, the first probe point 504A may be associated with the probe data 112 indicative of a starting probe point of the trajectory of the vehicle 104. The first probe point 504A may mark a beginning of a travel path of the vehicle 104. The travel path may be included in the probe data 112. For example, the first distance between first probe point 504A and the second probe point 504B is 30 meters and the time required to travel from the first probe point 504A to the second probe point 504B is 5 minutes, then the first probe point 504A and the second probe point 504B may be considered as the first trip and stored in the trip database. In an exemplary embodiment, the second distance between second probe point 504B and a third probe point 504C is 15 meters and the time required to travel from the second probe point 504B to the third probe point 504C is 3 minutes, then the second probe point 504B and the third probe point 504C may be considered as the first trip and stored in the trip database 336.

In an exemplary embodiment, a third distance between the third probe point 504C and a fourth probe point 504D is 20 meters and the time required to travel from the third probe point 504C to the fourth probe point 504D is 3 minutes, then the third probe point 504C and the fourth probe point 504D may be considered as the first trip and stored in the trip database 336. Similarly, a fourth distance between the fifth probe point 504D and a sixth probe point 504E, and a fifth distance between the fifth probe point 504E and a sixth probe point 504F, may be considered as the first trip and stored in the trip database 336.

In an exemplary embodiment, a fourth distance between the fourth probe point 504D and a fifth probe point 504E is 50 meters and the time required to travel from the fourth probe point 504D to fifth probe point 504E is 7 minutes, then the fourth probe point 504D and the fifth probe point 504E may be considered as the first trip and stored in the trip database 336.

In an exemplary embodiment, a fifth distance between the fifth probe point 504E and a sixth probe point 504F is 70 meters and the time required to travel from the fifth probe point 504E to the sixth probe point 504F is 8 minutes, then the fifth probe point 504E and the sixth probe point 504F may be considered as the first trip and stored in the trip database 336.

In an exemplary embodiment, a sixth distance between the sixth probe point 504F and a seventh probe point 504G is 200 meters and the time required to travel from the sixth probe point 504F to the seventh probe point 504G is 10 minutes, then the sixth probe point 504F to the seventh probe point 504G may not be considered as the first trip, these probe points may be considered as the second trip and stored in the trip database 336.

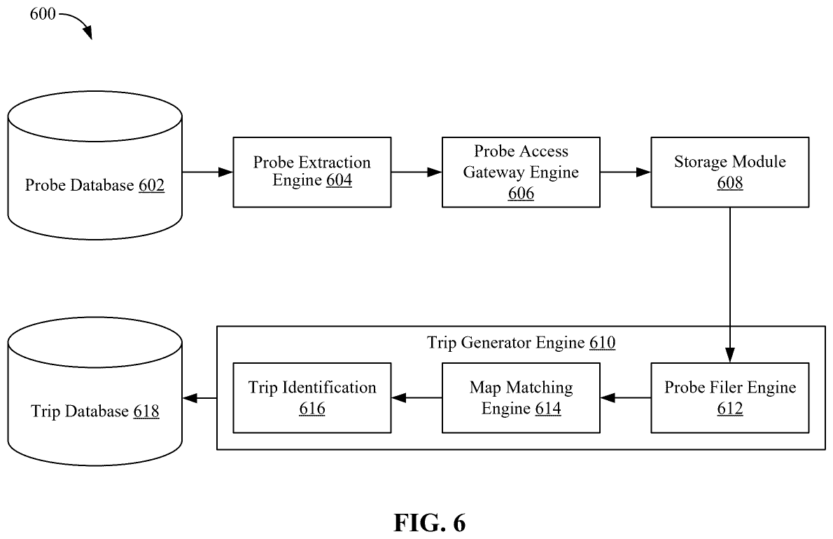

FIG. 6 illustrates a block diagram 600 of a trip generator engine associated with multiple components, in accordance with an embodiment of the disclosure. FIG. 6 is explained in conjunction with elements from FIG. 1, FIG. 2, FIG. 3A, FIG. 3B, FIG. 3C, FIG. 4 and FIG. 5. With reference to FIG. 6, there is shown the block diagram 600 of the trip generator engine associated with multiple components. The block diagram may include a probe database 602, a probe extractor engine 604, a probe access gateway engine 606, a storage module 608, and a trip generator engine 610.

The probe database 602 may store the probe data 112. In another embodiment, probe extractor engine 604 such as ‘Airflow’ may handle the integration of the probe data 112 from multiple data sources. The probe extractor engine 604 may further clean and reconcile the integrated data and prepare it for further analysis. In another embodiment, probe access gateway engine 606 may access the extracted data to process the extracted data. The extracted data may be used for monitoring and analyzing the performance of the vehicle 104. The extracted data may be used to generate real-time information, monitor traffic conditions, and help in providing information services. The probe access gateway engine 606 may provide a secure and controlled access to the probe data 112 that may ensure that the extracted probe data may be properly formatted and structured for further analysis and visualization. In another embodiment, the storage module 608 may store accessed data for future analysis and retrieval.

Upon storing the accessed data in the storage module 608, trip generator engine 610 may generate the trip information and store it in a trip database 618. The trip database 618 is an exemplary embodiment of the trip database 336 of FIG. 3. The trip information may be stored in the trip database 618 with the help of various engines, for example, probe filter engine 612, map matching engine 614, and trip identification engine 616. The trip generator engine 610 may include the probe filter engine 612 that may filter the accessed probe data based on the distance and time between two consecutive probe points. In an exemplary scenario, there are two probe points A and B. The distance between the first probe point A and the second probe point B is 200 meters, and the time taken to complete the distance between these two points is 10 minutes. In this case, the probe filter engine 612 may filter the first probe point A and the second probe point B for further analysis. The map matching engine 614 may combine the received journey data with the location information to obtain the real position of the vehicle 104 in the road network. The map matching engine 614 may involve matching recorded geographic coordinates to a logical model of the real world, typically using a Geographic Information System (GIS). The goal is to determine a sequence of connected road segments on a digital road network map that best approximates a route associated with the vehicle 104, even in the presence of errors and noise in the observed GPS data. After receiving the real position of the vehicle 104 on the road network and the selected particular ETA route, the trip may be identified by the trip identification engine 616 in the journey. Further, the identified trip may be stored in the trip database 618. The stored trip data in the trip database 618 may be leveraged for in-depth analysis of travel patterns, driver behavior, and transportation system performance to generate insights. The insights may inform the development of more effective and efficient transportation solutions, benefiting both transportation agencies and end-users.

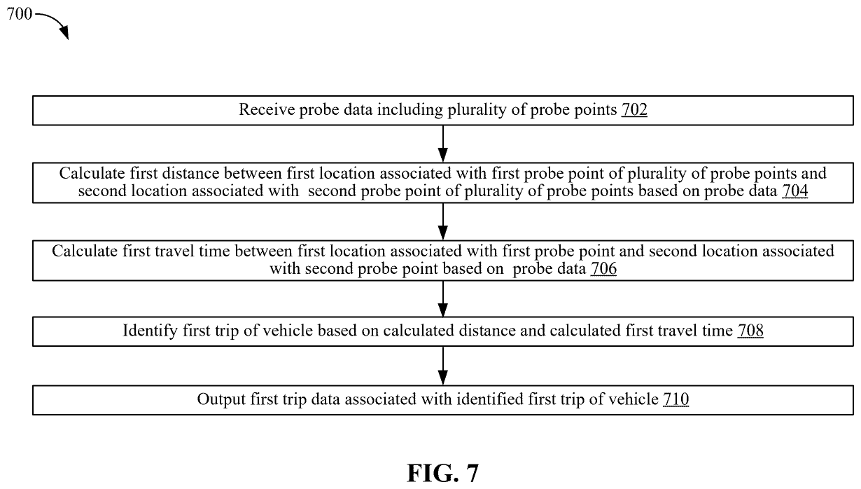

FIG. 7 illustrates a flow diagram of a method for identifying a trip taken by the vehicle using the probe data, in accordance with an embodiment of disclosure. FIG. 7 is explained in conjunction with elements from FIG. 1, FIG. 2, FIG. 3A, FIG. 3B, FIG. 3C, FIG. 4, FIG. 5, and FIG. 6. It will be understood that each block of the flow diagram of the flowchart 700 may be implemented by various means, such as hardware, firmware, processor, circuitry, and/or other communication devices associated with execution of software including one or more computer program instructions. For example, one or more of the procedures previously stated may be embodied by computer program instructions. In this regard, the computer program instructions which embody the procedures previously stated may be stored by a memory 204 of the system 102, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The flowchart 700 illustrated by the flowchart diagram of FIG. 7 is a flow chart for utilizing probe data to identify a trip of vehicle which may improve traffic analytics. Fewer, more, or different steps may be provided.

At 702, the probe data 112 may be received. In an embodiment, the system 102 may be configured to receive the probe data 112 including the plurality of probe points 114. The probe data 112 may be associated with the vehicle 104. Details about receiving the probe data 112 are provided, for example, in FIG. 3A.

At 704, the first distance may be calculated based on the probe data 112. In an embodiment, the system 102 may be configured to calculate the first distance between the first location associated with the first probe point 114A of the plurality of probe points 114 and the second location associated with the second probe point 114B of the plurality of probe points 114 based on the probe data 112. The second probe point 114B is consecutive to the first probe point 114A. Details about calculating the first distance are provided, for example, in FIG. 3B.

At 706, the first travel time may be calculated based on the probe data 112. In an embodiment, the system 102 may be configured to calculate the first travel time between the first location associated with the first probe point 114A and the second location associated with the second probe point 114B based on the probe data 112. Details about calculating the first travel time are provided, for example, in FIG. 3B.

At 708, the trip of the vehicle 104 may be identified based on the calculated distance and the calculated first travel time. In an embodiment, the system 102 may be configured to identify the first trip of the vehicle 104 based on the calculated distance and the calculated first travel time. The first trip may include at least one of the first probe point 114A, or the second probe point 114B. Details about identifying the first trip are provided, for example, in FIG. 3B.

At 710, the first trip data may be outputted. In an embodiment, the system 102 may be configured to output the first trip data associated with the identified first trip of the vehicle 104. Details about outputting the first trip data are provided, for example, in FIG. 3C.

Accordingly, blocks of the flowchart 700 support combinations of means for performing the specified functions and combinations of operations for performing the specified functions. It will also be understood that one or more blocks of the flowchart 700, and combinations of blocks in the flowchart 700, can be implemented by special-purpose hardware-based computer systems which perform the specified functions, or combinations of special-purpose hardware and computer instructions.

In some embodiments, the processor 202 may include means for performing each of the operations as mentioned earlier in conjunction with flowchart 700. In this regard, according to an example embodiment, examples of means for performing operations may comprise, for example, the processor and/or a device or circuit for executing instructions or executing an algorithm for processing information as described above.

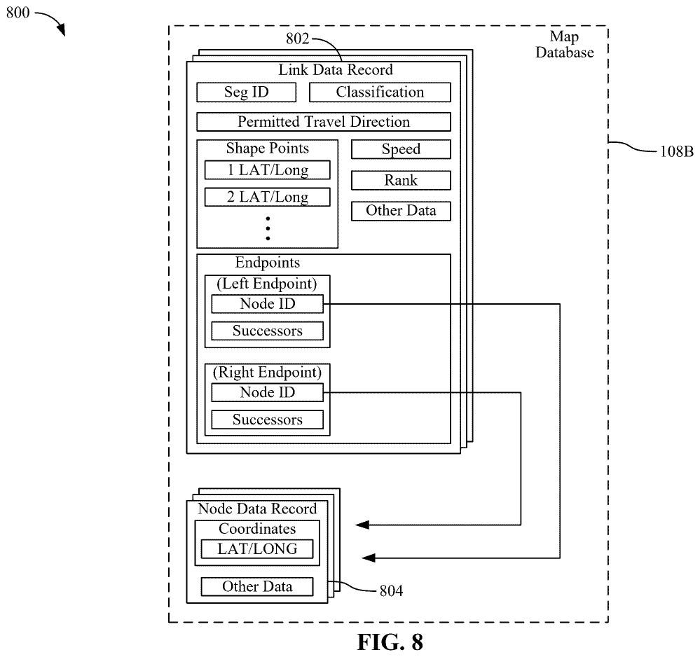

FIG. 8 illustrates an exemplary map database record storing data, in accordance with an embodiment of the disclosure. FIG. 8 is explained in conjunction with elements from FIG. 1, FIG. 2, FIG. 3A, FIG. 3B, FIG. 3C, FIG. 4, FIG. 5, FIG. 6, and FIG. 7. With reference to FIG. 8, there is shown a format of the map data 800 stored in the map database 108B according to one or more example embodiments. FIG. 8 shows a link data record 802 that may be used to store data associated with one or more of the feature lines. This link data record 802 may include information (such as “attributes”, “fields”, etc.) associated with it that may allow identification of the nodes associated with the link and/or the geographic positions (e.g., the latitude and longitude coordinates and/or altitude or elevation) of the two nodes. In addition, the link data record 802 may include information (e.g., more “attributes”, “fields”, etc.) that may specify the permitted speed of travel on a portion of the road may be represented by the link record, the direction of travel permitted on the road portion may be represented by the link record, if any turn restrictions may exist at each of the nodes corresponding to intersections at the ends of the road portion may be represented by the link record, the street address ranges of the roadway portion may be represented by the link record, the name of the road, and so on. The various attributes associated with a link may be included in a single data record or are included in more than one type of record which are referenced to each other.

Each link data record that may represent other-than-straight road segment may include shape point data. The shape point is a location along a link between its endpoints. To represent the shape of other-than-straight roads, the mapping platform 108 and its associated map database developer may select one or more shape points along the other-than-straight road portion. The shape point data may be included in the link data record 802 indicative of the position, (e.g., latitude, longitude, and optionally, altitude or elevation) of the selected shape points along the represented link.

Additionally, in the compiled geographic database, such as a copy of the map database 108B, there may also be a node data record 804 for each node. The node data record 804 may be associated with information (such as “attributes”, “fields”, etc.) that may allow identification of the link(s) that may connect to it and/or its geographic position (e.g., its latitude, longitude, and optionally altitude or elevation).

In some embodiments, compiled geographic databases may be organized to facilitate the performance of various navigation-related functions. One way to facilitate performance of navigation-related functions may be to provide separate collections or subsets of the geographic data for use by specific navigation-related functions. Each such separate collection may include the data and attributes needed for performing the associated function but may excludes data and attributes that may not be needed for performing the function. Thus, the map data may be alternately stored in a format suitable for performing types of navigation functions, and further may be provided on-demand, depending on the type of navigation function.

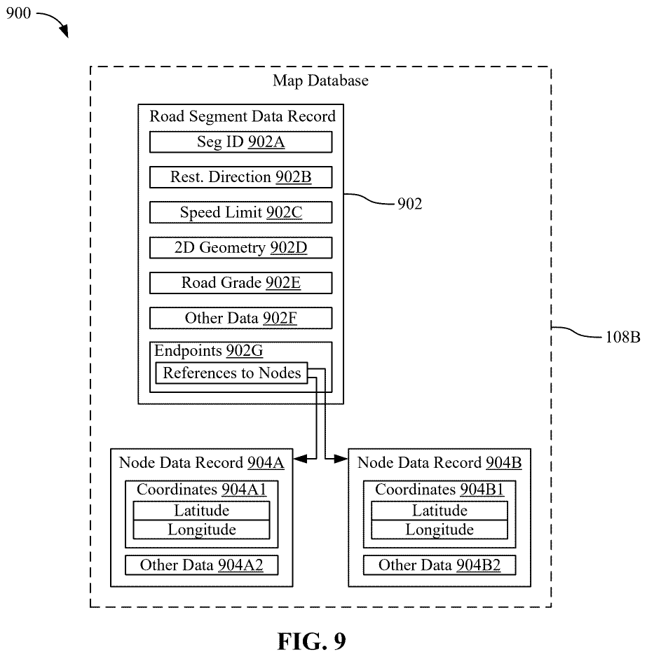

FIG. 9 is a diagram that illustrates an exemplary map database record storing data, in accordance with an embodiment of the disclosure. FIG. 9 is explained in conjunction with elements from FIG. 1, FIG. 2, FIG. 3A, FIG. 3B, FIG. 3C, FIG. 4, FIG. 5, FIG. 6, FIG. 7, and FIG. 8. With reference to FIG. 9, there is shown another format of the map data 900 stored in the map database 108B according to one or more example embodiments. In the FIG. 9, the map data 900 is stored by specifying a road segment data record 902. The road segment data record 902 is configured to represent data that represents a road network. In FIG. 9, the map database 108B contains at least one road segment data record 902 (also referred to as “entity” or “entry”) for each road segment in a geographic region.

The map database 108B that represents the geographic region of FIG. 8 may also include node data records 904 (a node data record 904A and a node data record 904B) (or “entity” or “entry”) for each node associated with the at least one road segment shown by the road segment data record 902. (The terms “nodes” and “segments” represent only one terminology for describing these physical geographic features and other terminology for describing these features is intended to be encompassed within the scope of these concepts). Each of the node data records 904A and 904B may have associated information (such as “attributes”, “fields”, etc.) that may allow identification of the road segment(s) that may connect to it and/or its geographic position (e.g., its latitude and longitude coordinates).

FIG. 9 depicts the components of road segment data record 902 contained in the map database 108B. The road segment data record 902 may include a segment ID 902A by which the data record may be identified in the map database 108B. The segment ID 902A may be associated with its information (such as “attributes”, “fields”, etc.) that may describe features of the represented road segment. The road segment data record 902 may include restriction direction data 902B that may indicate the restrictions, if any, on the direction of vehicular travel permitted on the represented road segment. The road segment data record 902 may include speed limit data 902C that may indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 902 may include 2D geometry data 902D indicative of two-dimensional (“2D”) geometry or shape of the road segment. If a road segment is straight, its shape may be represented by identifying its endpoints or nodes. However, if a road segment is other-than-straight, additional information may be required to indicate the shape of the road. One way to represent the shape of an other-than-straight road segment may be to use shape points. Shape points are points through which a road segment passes between its end points. By providing the latitude and longitude coordinates of one or more shape points, the shape of another-than-straight road segment may be represented. Another way of representing other-than-straight road segment may be with mathematical expressions, such as polynomial splines.

The road segment data record 902 may include road grade data 902E that may be indicative of the grade or slope of the road segment. In one embodiment, the road grade data 902E may include road grade change points and a corresponding percentage of grade change. Additionally, the road grade data 902E may include the corresponding percentage of grade change for both directions of a bi-directional road segment. The location of the road grade change point may be represented as a position along the road segment, such as thirty feet from the end or node of the road segment. For example, the road segment may have an initial road grade associated with its beginning node. The road grade change point may indicate position on the road segment wherein the road grade or slope changes, and percentage of grade change may indicate a percentage increase or decrease of the grade or slope. Each road segment may have several grade change points depending on the geometry of the road segment. In another embodiment, the road grade data 902E may include the road grade change points and an actual road grade value for the portion of the road segment after the road grade change point until the next road grade change point or end node. In an embodiment, the road grade data 902E may include elevation data at the road grade change points and nodes. In an alternative embodiment, the road grade data 902E may be an elevation model which may be used to determine the slope of the road segment.

The road segment data record 902 may include or be associated with other data 902F that may refer to various other attributes of the represented road segment. The various attributes associated with a road segment may be included in a single road segment record or may be included in more than one type of record which cross-reference of each other. For example, the road segment data record 902 may include data identifying the name or names by which the represented road segment is known, the street address ranges along the represented road segment, and or the like.

The road segment data record 902 may include endpoints 902G providing the geographic coordinates (e.g., the latitude and longitude) of the end points of the represented road segment. In one embodiment, the endpoints 902G may be references to the node data records 904 that may represent the nodes corresponding to the end points of the represented road segment.

FIG. 9 may represent components of the node data records 904 contained in the map database 108B. Each of the node data records 904 may include associated information (such as “attributes”, “fields”, etc.) that may allow identification of the road segment(s) that may connect to it and/or it is geographic position (e.g., its latitude and longitude coordinates). For the embodiment shown in FIG. 9, the node data records 904 including 904A and 904B that may include the latitude and longitude coordinates 904A1 and 904B1 for their nodes accordingly. The node data records 904 including 904A and 904B may also include other data 904A2 and 904B2 that may refer to various other attributes of the nodes.

Thus, the overall data stored in the map database 108B may be organized in the form of different layers for greater detail, clarity, and precision. Specifically, in the case of high-definition maps, the map data may be organized, stored, sorted, and accessed in the form of three or more layers. The layers may include road level layer, lane level layer and localization layer. The data stored in the map database 108B may be stored in the formats shown in FIGS. 8 and 9. The data stored in the map database 108B may be combined in a suitable manner to provide these three or more layers of information. In an embodiment, there may be lesser or fewer number of layers of data possible, without deviating from the scope of the present disclosure.

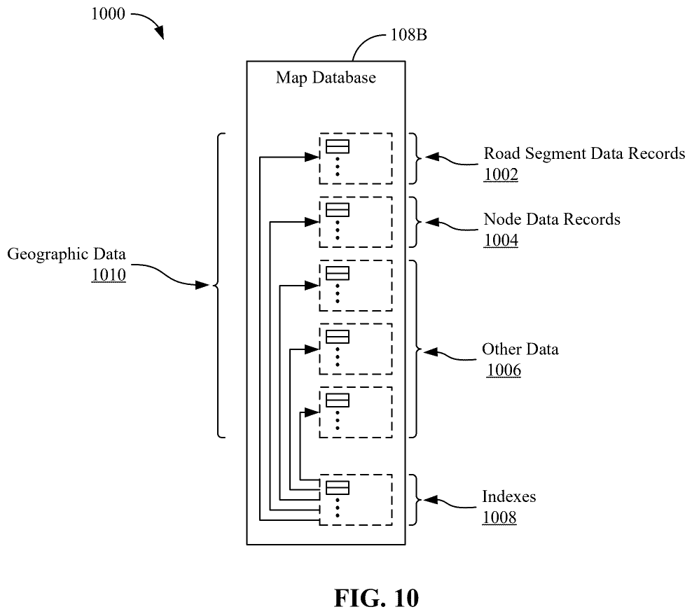

FIG. 10 illustrates a block diagram 1000 of the map database 108B storing map data or geographic data 1010 in the form of road segments/links, nodes, and one or more associated attributes as discussed above. Furthermore, attributes may refer to features or data layers associated with the link-node database, such as an HD lane data layer.

In addition, the geographic data 1010 may include other kinds of data 1006. The other kinds of data 1006 may represent other kinds of geographic features. The other kinds of data 1006 may include point of interest data. For example, the point of interest data may include point of interest records comprising a type (e.g., the type of point of interest, such as restaurant, ATM, etc.), location of the point of interest, a phone number, hours of operation, etc. The map database 108B may include indexes 1008. The indexes 1008 may include various types of indexes that may relate with the different types of data to each other or may relate to other aspects of the data contained in the map database 108B. The road segment data records 1002 is an exemplary embodiment of the road segment data record 902 of FIG. 9. The node data records 1004 is an exemplary embodiment of the node data records 904 of FIG. 9.

The data stored in the map database 108B in the various formats discussed above may help in providing precise data for high-definition mapping applications, autonomous vehicle navigation and guidance, cruise control using ADAS, direction control using accurate vehicle manoeuvring and other such services. In an embodiment, the system 102 may be configured to access the map database 108B. The map database 108B may store data in form of various layers and formats depicted in FIG. 8, FIG. 9 and FIG. 10. The map database 108B may additionally store the image data and the optimized model used for inference deduction that may be accessed by the user device for faster processing.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A system, comprising:
a memory to store computer-executable instructions; and
one or more processors coupled to the memory, wherein the one or more processors are configured to:
receive probe data comprising a plurality of probe points, wherein the probe data is associated with a vehicle;
calculate a first distance between a first location associated with a first probe point of the plurality of probe points and a second location associated with a second probe point of the plurality of probe points based on the probe data, wherein the second probe point is consecutive to the first probe point;
calculate a first travel time between the first location associated with the first probe point and the second location associated with the second probe point based on the probe data;
identify a first trip of the vehicle based on the calculated distance and the calculated first travel time, wherein the first trip comprises at least one of: the first probe point, or the second probe point; and
output, based on the probe data, first trip data associated with the identified first trip of the vehicle.

2. The system of claim 1, wherein the one or more processors are further configured to identify the first trip of the vehicle to include the first probe point and the second probe point based on a determination that the calculated distance is less than a distance threshold and the calculated first travel time is less than a time threshold.

3. The system of claim 2, wherein the one or more processors are further configured to:
compare the calculated first travel time with a first-time threshold and a second time threshold;
determine a waiting time associated with the calculated first travel time between the first probe point and the second probe point based on the comparison; and
output, based on the probe data, the first trip data associated with the identified first trip of the vehicle, wherein the first trip data comprises the determined waiting time.

4. The system of claim 1, wherein the one or more processors are further configured to:
obtain, from a map database, tile level data associated with each of the first probe point and the second probe point; and
output, based on the obtained tile level data, first trip data associated with the identified first trip of the vehicle, wherein the first trip data comprises the obtained tile level data.

5. The system of claim 1, wherein the one or more processors are configured to:
determine a probe count of the plurality of the probe points based on the received probe data;
identify a journey of the vehicle based on a comparison of the determined probe count with a probe count threshold; and
identify the first trip of the vehicle within the identified journey.

6. The system of the claim 1, wherein the first trip data associated with the identified first trip comprises distance data indicative of a distance travelled by the vehicle in the first trip, time data associated with a duration of the first trip, probe frequency data, and location data associated with each of an origin and a destination of the first trip.

7. The system of claim 6, wherein the location data associated with the origin and the destination of the first trip is determined based on the first location associated with the first probe point and the second location associated with the second probe point.

8. The system of claim 1, wherein the one or more processors are configured to:
generate a first unique identifier associated with the first trip based on the received probe data;
associate the first unique identifier with the first trip, wherein the first trip comprises the first trip data; and
store the first trip data in one or more databases, wherein the first trip data is associated with the first trip.

9. The system of claim 1, wherein the one or more processors are further configured to:
calculate a second distance between a second location associated with the second probe point of the plurality of probe points and a third location associated with a third probe point of the plurality of probe points, based on the probe data, wherein the third probe point is consecutive to the second probe point;
calculate a second travel time between the second location and the third location based on the probe data; and
identify the first trip of the vehicle based on a determination that the calculated second distance is less than a distance threshold and the calculated second travel time is less than a time threshold, wherein the first trip includes the third probe point.

10. The system of claim 1, wherein the one or more processors are further configured to:
calculate a second distance between a second location associated with the second probe point of the plurality of probe points and a third location associated with a third probe point of the plurality of probe points based on the probe data, wherein the third probe point is consecutive to the second probe point;
calculate a second travel time between the second location and the third location based on the probe data; and
identify a second trip of the vehicle based on a determination that the calculated second distance is greater than a distance threshold and the calculated second travel time is greater than a time threshold, wherein the second trip includes the third probe point.

11. The system of claim 10, wherein the one or more processors are further configured to:
determine second trip data associated with the identified second trip of the vehicle;
generate a second unique identifier associated with the second trip based on the received probe data;
associate the second unique identifier with the second trip, wherein the second trip comprises the second trip data; and
store the second trip data in one or more databases, wherein the second trip data is associated with the second trip.

12. A method, comprising:
receiving probe data comprising a plurality of probe points, wherein the probe data is associated with a vehicle;
calculating a first distance between a first location associated with a first probe point of the plurality of probe points and a second location associated with a second probe point of the plurality of probe points based on the probe data, wherein the second probe point is consecutive to the first probe point;
calculating a first travel time between the first location associated with the first probe point and the second location associated with the second probe point based on the probe data;
identifying a first trip of the vehicle based on the calculated distance and the calculated first travel time, wherein the first trip comprises at least one of: the first probe point, or the second probe point; and
outputting, based on the probe data, first trip data associated with the identified first trip of the vehicle.

13. The method of claim 12, wherein the method further comprising identifying the first trip of the vehicle to include the first probe point and the second probe point based on a determination that the calculated distance is less than a distance threshold and the calculated first travel time is less than a time threshold.

14. The method of claim 13, wherein the method further comprising:
comparing the calculated first travel time with a first-time threshold and a second time threshold;
determining a waiting time associated with the calculated first travel time between the first probe point and the second probe point based on the comparison; and
outputting, based on the probe data, the first trip data associated with the identified first trip of the vehicle, wherein the first trip data comprises the determined waiting time.

15. The method of claim 12, wherein the method further comprising:
obtaining, from a map database, tile level data associated with each of the first probe point and the second probe point; and
outputting, based on the obtained tile level data, first trip data associated with the identified first trip of the vehicle, wherein the first trip data comprises the obtained tile level data.

16. The method of claim 12, wherein the method further comprising:
determining a probe count of the plurality of the probe points based on the received probe data;
identifying a journey of the vehicle based on a comparison of the determined probe count with a probe count threshold; and
identifying the first trip of the vehicle within the identified journey.

17. The method of claim 12, wherein the method further comprising:
generating a first unique identifier associated with the first trip based on the received probe data;
associating the first unique identifier with the first trip, wherein the first trip comprises the first trip data; and
storing the first trip data in one or more databases, wherein the first trip data is associated with the first trip.

18. The method of claim 12, wherein the method further comprising:
calculating a second distance between a second location associated with the second probe point of the plurality of probe points and a third location associated with a third probe point of the plurality of probe points based on the probe data, wherein the third probe point is consecutive to the second probe point;
calculating a second travel time between the second location and the third location associated with the second probe point based on the probe data; and
identifying the first trip of the vehicle based on a determination that the calculated second distance is less than a distance threshold and the calculated second travel time is less than a time threshold, wherein the first trip includes the third probe point.

19. The method of claim 18, wherein the method further comprising:
calculating a second distance between a second location associated with the second probe point of the plurality of probe points and a third location associated with a third probe point of the plurality of probe points based on the probe data, wherein the third probe point is consecutive to the second probe point;
calculating a second travel time between the second location and the third location associated with the second probe point based on the probe data; and
identifying a second trip of the vehicle based on a determination that the calculated second distance is greater than a distance threshold and the calculated second travel time is greater than a time threshold, wherein the second trip includes the third probe point.

20. A computer programmable product comprising a non-transitory computer readable medium having stored thereon computer executable instructions, which when executed by one or more processors, cause the one or more processors to conduct operations, comprising:
receiving probe data comprising a plurality of probe points, wherein the probe data is associated with a vehicle;
calculating a first distance between a first location associated with a first probe point of the plurality of probe points and a second location associated with a second probe point of the plurality of probe points based on the probe data, wherein the second probe point is consecutive to the first probe point;
calculating a first travel time between the first location associated with the first probe point and the second location associated with the second probe point based on the probe data;
identifying a first trip of the vehicle based on the calculated distance and the calculated first travel time, wherein the first trip comprises at least one of: the first probe point, or the second probe point; and
outputting, based on the probe data, first trip data associated with the identified first trip of the vehicle.
